(19) United States
(12) Patent Application Publication
(10) Pub. No.: US 2026/0095358 A1
(43) Pub. Date: Apr. 2, 2026

(54) ENHANCED CONFIGURATION OF CHANNEL SOUNDING SIGNAL FOR BANDWIDTH STITCHING FOR WIRELESS DEVICE POSITIONING

(71) Applicant: INTEL CORPORATION, Santa Clara, CA (US)

(72) Inventors: Guotong WANG, Beijing (CN); Gang XIONG, Portland, OR (US); Debdeep CHATTERJEE, San Jose, CA (US); Jihyun LEE, Santa Clara, CA (US)

(73) Assignee: INTEL CORPORATION, Santa Clara, CA (US)

(21) Appl. No.: 19/111,278

(22) PCT Filed: Oct. 5, 2023
(86) PCT No.: PCT/US2023/076074

§ 371 Date: Mar. 12, 2025

Related U.S. Application Data
(60) Provisional application No. 63/415,036, filed on Oct. 11, 2022.
(60) Provisional application No. 63/424,709, filed on Nov. 11, 2022.
(60) Provisional application No. 63/501,284, filed on May 10, 2023.

(51) Int. Cl. H04L 27/26; H04L 5/00

(52) U.S. Cl. CPC H04L 27/261; H04L 5/0044

(57) ABSTRACT

This disclosure describes systems, methods, and devices for configuring sounding reference signal resources across multiple frequency locations for device positioning. A device may encode for transmission a sounding reference signal (SRS) including a first set of SRS resources for a first transmission by a user equipment (UE) device to the node B network device at a first time and a second set of SRS resources for a second transmission by the UE device to the node B network device at a second time; decode the first transmission received from the UE device using the first set and a first bandwidth at the first time; decode the second transmission received from the UE device using the second set and a second bandwidth at the second time; and combine the first transmission and the second transmission for a device positioning estimation based on the first bandwidth and the second bandwidth.

### CROSS-REFERENCE TO RELATED PATENT APPLICATION(S)

This application claims the benefit of and claims priority to U.S. Provisional Application No. 63/415,036, filed Oct. 11, 2022, to U.S. Provisional Application No. 63/424,709, filed Nov. 11, 2022, and to U.S. Provisional Application No. 63/501,284, filed May 10, 2023, the disclosures of which are incorporated herein by reference as if set forth in full.

### TECHNICAL FIELD

This disclosure generally relates to systems and methods for wireless communications and, more particularly, to a configuration for channel sounding.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2A illustrates an example process for wireless device positioning using sounding reference signal (SRS) bandwidth stitching via multiple SRS resources for multiple different bandwidth parts (BWPs), in accordance with one or more example embodiments of the present disclosure.

FIG. 2B illustrates an example process for wireless device positioning using SRS bandwidth stitching via multiple SRS resources for multiple different BWPs, in accordance with one or more example embodiments of the present disclosure.

FIG. 3A illustrates an example process for wireless device positioning using SRS bandwidth stitching via one SRS resource set for multiple different BWPs, in accordance with one or more example embodiments of the present disclosure.

FIG. 3B illustrates an example process for wireless device positioning using SRS bandwidth stitching via one SRS resource set for multiple different BWPs, in accordance with one or more example embodiments of the present disclosure.

FIG. 4A illustrates an example process for wireless device positioning using SRS bandwidth stitching via one SRS resource set for multiple different BWPs, in accordance with one or more example embodiments of the present disclosure.

FIG. 4B illustrates an example process for wireless device positioning using SRS bandwidth stitching via one SRS resource set for multiple different BWPs, in accordance with one or more example embodiments of the present disclosure.

FIG. 5A illustrates an example process for wireless device positioning using SRS bandwidth stitching via one SRS resource set for multiple different BWPs, in accordance with one or more example embodiments of the present disclosure.

FIG. 5B illustrates an example process for wireless device positioning using SRS bandwidth stitching via one SRS resource set for multiple different BWPs, in accordance with one or more example embodiments of the present disclosure.

FIG. 6A illustrates an example process for wireless device positioning using SRS bandwidth stitching via SRS resource sets for multiple different BWPs, in accordance with one or more example embodiments of the present disclosure.

FIG. 6B illustrates an example process for wireless device positioning using SRS bandwidth stitching via SRS resource sets for multiple different BWPs, in accordance with one or more example embodiments of the present disclosure.

FIG. 7A illustrates an example process for wireless device positioning using SRS bandwidth stitching via SRS resource sets for multiple different BWPs, in accordance with one or more example embodiments of the present disclosure.

FIG. 7B illustrates an example process for wireless device positioning using SRS bandwidth stitching via SRS resource sets for multiple different BWPs, in accordance with one or more example embodiments of the present disclosure.

FIG. 8 illustrates an example process for wireless device positioning with SRS collision handling, in accordance with one or more example embodiments of the present disclosure.

FIG. 9 illustrates a flow diagram of illustrative process for wireless device positioning using SRS bandwidth stitching via multiple SRS resources for multiple different BWPs, in accordance with one or more example embodiments of the present disclosure.

FIG. 10. illustrates a network, in accordance with one or more example embodiments of the present disclosure.

FIG. 11 schematically illustrates a wireless network, in accordance with one or more example embodiments of the present disclosure.

FIG. 12 is a block diagram illustrating components, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including for wireless device positioning. In 3GPP, a user equipment (UE) and a gNB/eNB may exchange sounding reference signals that allow each other to estimate their distances from one another based on arrival and departure times. The 3GPP 5G new radio (NR) standard supports highly precise positioning in the vertical and horizontal dimensions, which relies on timing-based, angle-based, power-based, or hybrid techniques to estimate user location in the network. In particular, the following RAT dependent positioning techniques may meet the positioning requirements for various use cases, e.g., indoor, outdoor, Industrial internet of thing (IoT), etc.: downlink time difference of arrival (DL-TDOA), uplink time difference of arrival (UL-TDOA), downlink angle of departure (DL-AoD), uplink angle of arrival (UL AoA), multi-cell round trip time (multi-RTT), and NR enhanced cell ID (E-CID).

With wide bandwidth for positioning signal and beamforming capability in the mmWave (millimeter wave) frequency band (e.g., between 24 GHz and 40 GHz), higher positioning accuracy can be achieved by RAT-dependent (radio access technology) positioning techniques. In 3GPP Rel-16 (Release 16), a downlink positioning reference signal (DL-PRS) and an uplink sounding reference signal (UL-SRS) for positioning were introduced as enablers to achieve target performance characteristics.

It is beneficial to support a class of NR UEs with complexity and power consumption levels lower than Rel-15 NR UEs, catering to use cases like industrial wireless sensor networks (IWSN), certain classes of wearables, and video surveillance, to fill the gap between current low-power wide-area (LPWA) solutions and eMBB solutions in NR, and also to further facilitate a smooth migration from 3.5G and 4G technologies to 5G (NR) technology for currently deployed bands serving relevant use cases requiring relatively low-to-moderate reference (e.g., median) and peak user throughputs, low device complexity, small device form factors, and relatively long battery lifetimes.

Towards the above, a class of Reduced Capability (RedCap) NR User Equipment (UE) is expected to be defined, and which may be served using the currently specified 5G NR framework with necessary adaptations and enhancements to limit device complexity and power consumption while minimizing any adverse impact to network resource utilization, system spectral efficiency, and operation efficiency. In particular, RedCap UEs support a maximum UE BW of 20 MHz in frequency range 1 (FR1) bands and a maximum UE BW of 100 MHz in FR2 bands.

For RedCap UEs, bandwidth limitation may lead to insufficient resolution in the time domain and may affect the accuracy of the DL-TDOA, UL-TDOA, and Multi-RTT timing-based positioning methods. To improve the positioning accuracy, frequency hopping with a bandwidth stitching method can be considered for the transmission of DL-PRS and/or UL-SRS for positioning, wherein two consecutive frequency hops share a number of overlapped PRBs. In this case, multiple channel observations obtained with frequency hopping measurements can be processed at the receiver side to “stitch” them into a wideband channel realization, which would result in a sample time duration reduction and the discrete Fourier size extension.

In one or more embodiments, the present disclosure describes systems and methods for the configuration of a sounding reference signal for bandwidth stitching for positioning. In particular, the present disclosure proposes: (1) bandwidth stitching via one sounding reference signal (SRS) resource set, and multiple SRS resources associated with different component carriers (CC)/bandwidth parts (BWP); (2) bandwidth stitching via one SRS resource set associated with different CCs/BWPs; (3) bandwidth stitching via SRS resource sets over different CCs/BWPs; and (4) collision handling of SRS for positioning with other uplink transmission.

In one embodiment, a UE may be configured with component carriers (CC)/bandwidth parts (BWP) used for transmission of SRS for positioning with frequency hopping such that the CCs/BWPs have non-zero frequency domain overlaps between any two consecutive frequency hops.

In another embodiment, a UE may be configured with UL BWPs used for transmission of SRS for positioning with frequency hopping such that the UL BWPs may not have frequency overlaps while the bandwidth for SRS for positioning associated with a BWP may exceed the bandwidth of the UL BWP. In one variant of this embodiment, a UE may expect the bandwidth for SRS for positioning transmission to map to resources beyond the associated UL BWP, except for the active UL BWP.

In another embodiment, except for the active UL BWP, SRS for positioning resources outside of the active UL BWP may be defined directly on the common resource block (CRB) grid on the UL carrier. In this case, the UE may be configured with a common numerology (subcarrier spacing (SCS) and cyclic prefix (CP) length)) for use in each of the frequency hops or be provided with different numerology across the frequency hops. In one example, the common numerology may follow that defined for the UL carrier.

In another embodiment, except for the active UL BWP, SRS for positioning resources outside of the active UL BWP may be associated with UL frequency regions defined on the CRB grid instead of UL BWPs. In this case, the UE may be configured with a common numerology (subcarrier spacing (SCS) and cyclic prefix (CP) length)) for use in each of the frequency hops or be provided with different numerology across the frequency hops. In one example, the common numerology may follow that defined for the UL carrier.

In another embodiment, the bandwidths of the different frequency hops as well as the bandwidths of the SRS resource may be same.

In another embodiment, the bandwidths of the different frequency hops as well as the bandwidths of the SRS resource may be separately provided.

In another embodiment, the bandwidths of the different frequency hops, e.g., bandwidths of the CCs or BWPs or frequency regions not included within the active UL BWP may be different but the bandwidth of the SRS resource in each hop may be same.

In another embodiment, a UE may be configured to transmit using UL transmission power control (TPC) parameters defined for the active UL BWP.

In another embodiment, a UE may be configured to transmit using UL TPC parameters that may be separately provided for each frequency hop.

While the embodiments and examples in the present disclosure are described using CCs or BWPs, these techniques can be applied to scenarios that do not associate the frequency hops outside of active UL BWP with other CCs/BWPs as well.

Embodiments of bandwidth stitching via one SRS resource set, and multiple SRS resources associated with different CCs/BWPs are provided as follows.

In one embodiment, for positioning SRS, the frequency hopping with bandwidth stitching could be achieved by configuring one SRS resource set containing multiple SRS resources, wherein the SRS resources could be associated with different CCs/BWPs (the association could be configured at SRS resource level by RRC). The configured bandwidth for each SRS resource could be the same or different.

The SRS resource set(s) for positioning could be configured on the current scheduling CC/BWP. When transmitting the SRS resource set, the SRS resources could be transmitted over the associated CC/BWP. When switching across different CCs/BWPs, gap period should be defined to perform the RF retuning. The time interval between two adjacent SRS transmission over different CC/BWP should be larger than or equal to the required gap period.

In a first option, the gap period is prior to and after the SRS transmission over the CC/BWP other than the current scheduling CC/BWP. In a second option, the gap period is after the SRS transmission over the current scheduling CC/BWP, and the gap period is also after the SRS transmission over the CC other than the current scheduling CC/BWP. In a third option, for operation with more than two CCs/BWPs, after transmitting one SRS resource over the CC/BWP other than the scheduling CC/BWP, the UE should always switch back to the scheduling CC/BWP. In a fourth option, for operation with more than two CCs/BWPs, after transmitting one SRS resource over the CC/BWP other than the scheduling CC/BWP, the UE could stay over the CC/BWP, and then switch to another CC/BWP for the next SRS transmission.

In another embodiment, when the SRS resource is transmitted over different CC/BWP, the starting position in frequency domain for SRS may be determined for each CC/BWP respectively. The starting position in frequency may be defined relative to the subcarrier 0 in common resource block 0, lowest subcarrier of the current scheduling CC/BWP, or the lowest subcarrier of the CC/BWP over which the SRS resource will be transmitted. In one example, the starting position in frequency could be configured for each SRS resource, wherein the existing parameter freqDomainShift could be reused or a new parameter could be defined.

In another embodiment, for periodic/semi-persistent SRS resource set configured on the current scheduling CC/BWP, the SRS resources could be further associated with different CCs/BWPs. Correspondingly, different offsets could be configured for the SRS resource associated with different CCs/BWPs (different periodicity could also be configured if the numerology may be different for different CCs/BWPs). A new MAC-CE could be introduced to update the association between SRS resource and CCs/BWPs, and the corresponding periodicity and offset. MAC-CE could also be used to activate/deactivate one or more SRS resources in the SRS resource set.

In another embodiment, for aperiodic SRS resource set for positioning, the SRS resources could be associated with different CCs/BWPs. Correspondingly, the slot offset, or the available slot should be configured at SRS resource level, and different slot offset, or available slot could be configured for SRS resources associated with different CC/BWP.

In one example, the slot offset/available slot configuration should guarantee that the first SRS transmission is over the scheduling CC/BWP. A new MAC-CE could be introduced to update the association between SRS resource and CCs/BWPs, and the corresponding slot offset/available slot. MAC-CE could also be used to activate/deactivate some SRS resources in the SRS resource set.

When a downlink control information (DCI) is received triggering the aperiodic SRS resource set, the SRS resources could be transmitted over associated CC/BWP. In some aspects, the DCI could be any format that carries SRS Request field.

For aperiodic SRS transmission for positioning, if the more than one SRS resources are configured within different BWPs, the BWP used for the first SRS resource is determined in accordance with the indicated BWP index in the scheduling DCI.

Embodiments of bandwidth stitching via one SRS resource set associated with different CCs/BWPs are provided as follows:

In one embodiment, for positioning SRS, frequency hopping with bandwidth stitching may be supported by configuring one SRS resource set associated with different CCs/BWPs. SRS resource set(s) for positioning could be configured on the current scheduling CC/BWP and the SRS resource set(s) could be associated with multiple CCs/BWPs (the association could be configured at SRS resource set level by RRC). When switching across different CCs/BWPs, gap period should be defined to perform the RF retuning. The time interval between two adjacent SRS transmission over different CC/BWP should be larger than or equal to the required gap period.

In a first option, the gap period is prior to and after the SRS transmission over the CC/BWP other than the current scheduling CC/BWP. In a second option, the gap period is after the SRS transmission over the current scheduling CC/BWP, and the gap period is also after the SRS transmission over the CC other than the current scheduling CC/BWP. In a third option, for operation with more than two CCs/BWPs, after the SRS transmission over the CC/BWP other than the scheduling CC/BWP, the UE should always switch back to the scheduling CC/BWP. In a fourth option, for operation with more than two CCs/BWPs, after the SRS transmission over the CC/BWP other than the scheduling CC/BWP, the UE could stay over the CC/BWP, and then switch to another CC/BWP for the next SRS transmission.

In another embodiment, when SRS is transmitted over different CC/BWP, the starting position in frequency domain for SRS should be determined for each CC/BWP respectively. The starting position in frequency could be defined in relative to the subcarrier 0 in common resource block 0, or the starting position in frequency could be defined in relative to the lowest subcarrier of the current scheduling CC/BWP, or the starting position in frequency could be defined in relative to the lowest subcarrier of the CC/BWP over which the SRS will be transmitted. In one example, the starting position in frequency could be configured for each associated CC/BWP.

In another embodiment, for periodic/semi-persistent SRS resource set configured on the current scheduling CC/BWP, the resource set could be associated with multiple CCs/BWPs by RRC signaling, and correspondingly, the periodicity and offset could be configured with for each associated CC/BWP (different periodicity could also be configured if the numerology is different for different CCs/BWPs). A new MAC-CE could be introduced to update the associated CCs/BWPs and corresponding periodicity and offset.

In another embodiment, for aperiodic SRS resource set, it is configured on the current scheduling CC/BWP. In the aperiodic SRS resource set, it could be associated with multiple CCs/BWPs (the association is configured at SRS resource set level by RRC), and correspondingly the slot offset, or the available slot should be configured with each associated CC/BWP (in one example, the slot offset/available slot configuration should guarantee that the first SRS transmission is over the scheduling CC/BWP). A new MAC-CE could be introduced to update the associated CCs/BWPs and the corresponding slot offset/available slot. When DCI (the DCI could be any format that carrying SRS Request field) is received triggering the aperiodic SRS resource set, the SRS resource set will be transmitted over each associated CC/BWP. Alternatively, the DCI could indicate multiple CCs/BWPs (it could be a new filed or re-use existing field or re-purpose un-used field) over which the triggered SRS resource set will be transmitted (in this case, the association with CCs/BWPs may not be configured by RRC, or the association is configured but it is updated by the DCI).

Embodiments of bandwidth stitching via SRS resource sets over different CCs/BWPs are provided as follows:

In one embodiment, for positioning SRS, frequency hopping with bandwidth stitching could be achieved by multiple SRS resource sets configured for different CCs/BWPs with a single SRS resource set for positioning configured for each a single CC/BWP. When switching across different CCs/BWPs, gap period should be defined to perform the RF retuning. The time interval between two adjacent SRS transmission over different CC/BWP should be larger than or equal to the required gap period.

In one option, the gap period is prior to and after the SRS resource set, which is transmitted over the CC/BWP other than the current scheduling CC/BWP. In another option, the gap period is after the SRS resource set which is transmitted over the current scheduling CC/BWP, and the gap period is also after the SRS resource set which is transmitted over the CC/BWP other than the current scheduling CC/BWP. In a third option, for operation with more than two CCs/BWPs, after the SRS transmission over the CC/BWP other than the scheduling CC/BWP, the UE should always switch back to the scheduling CC/BWP. In a fourth option, for operation with more than two CCs/BWPs, after the SRS transmission over the CC/BWP other than the scheduling CC/BWP, the UE could stay over the CC/BWP, and then switch to another CC/BWP for the next SRS transmission.

In another embodiment, for periodic/semi-persistent SRS, multiple periodic/semi-persistent SRS resource set(s) could be configured, each associated with a CC/BWP. A new MAC-CE could be introduced to activate/deactivate the periodic/semi-persistent SRS transmission over multiple CCs/BWPs.

In another embodiment, for aperiodic SRS, multiple SRS resource set(s) could be configured, each associated with a CC/BWP. The SRS resource sets should be configured with the same trigger state.

In one option, the carrier indicator field in the DCI (DCI format 0_1/0_2/1_1/1_2) could be extended to a bitmap, so that the aperiodic SRS resource sets over different CCs/BWPs could be triggered. Or some un-used field(s) in the DCI (0_1/0_2/1_1/1_2) without scheduling could be repurposed to indicate multiple CCs/BWPs for SRS transmission. In another option, a group common DCI could be used to trigger the SRS resource sets over different CCs/BWPs. The existing DCI 2_3 could be reused, or a new group common DCI could be defined.

Collision handling of SRS for positioning with other uplink transmission (in the following embodiments, the terminology “uplink time window”, “measurement gap”, “SRS for positioning transmission window” are exchangeable). Embodiments of collision handling of SRS for positioning with other uplink transmission are provided as follows:

In one embodiment, a measurement gap or SRS for positioning transmission window may be defined. In this case, SRS for positioning across different BWPs/CCs or with frequency hopping may be transmitted within the measurement gap or SRS processing window.

In one option, within the measurement gap or SRS for positioning transmission window, if the transmission of SRS for positioning collides in time with other DL signals or channels or UL signals or channels, the SRS for positioning is prioritized, which may depend on UE capability. In this case, other DL signals/channels or UL signals/channels may be cancelled.

As a further extension, within the measurement gap or uplink time window for SRS for positioning with frequency hopping, if the transmission of SRS for positioning collides in time with other DL signals or channels or UL signals or channels except SSB, PRACH, Msg2 including PDCCH for scheduling Msg2 and associated PDSCH during the RAR window, Msg3, Msg4 including PDCCH for scheduling Msg4 and associated PDSCH during the contention resolution window, MsgA PRACH, MsgA PUSCH, MsgB and/or PUCCH carrying HARQ-ACK in response to Msg4 and MsgB, the SRS for positioning is prioritized, which may depend on UE capability. In this case, other DL signals/channels or UL signals/channels except PRACH, Msg2 including PDCCH for scheduling Msg2 and associated PDSCH during the RAR window, Msg3, Msg4 including PDCCH for scheduling Msg4 and associated PDSCH during the contention resolution window, MsgA PRACH, MsgA PUSCH, MsgB and/or PUCCH carrying HARQ-ACK in response to Msg4 and MsgB may be cancelled.

In another option, a measurement gap or uplink time window for transmission of SRS for positioning with frequency hopping may be configured to a UE in RRC_CONNECTED mode. Further, within the measurement gap or SRS for positioning transmission window for transmission of SRS for positioning with frequency hopping, if the transmission of SRS for positioning collides in time with other DL signals or channels or UL signals or channels except SSB, Msg2 including PDCCH for scheduling Msg2 and associated PDSCH during the RAR window, Msg3 PUSCH and associated scheduling PDCCH scheduling Msg3 retransmission, MsgA PUSCH and associated scheduling PDCCH scheduling MsgA PUSCH retransmission, MsgB and/or PUCCH carrying HARQ-ACK in response to MsgB, the SRS for positioning is prioritized, which may depend on UE capability. In this case, other DL signals/channels or UL signals/channels except SSB, Msg2 including PDCCH for scheduling Msg2 and associated PDSCH during the RAR window, Msg3 PUSCH and associated scheduling PDCCH scheduling Msg3 retransmission, MsgA PUSCH and associated scheduling PDCCH scheduling MsgA PUSCH retransmission, MsgB and/or PUCCH carrying HARQ-ACK in response to MsgB may be cancelled.

If the transmission of SRS for positioning with frequency hopping outside the initial BWP in RRC_INACTIVE mode along with any switching time collides in time domain with other DL signals or channels or UL signals or channels, the SRS for positioning transmission may be dropped in the symbol(s) where the collision occurs. In an example, the switching time may correspond the value indicated in higher layer parameter switchingTimeSRS-TX-OtherTX. In one example, in case of collision, all frequency hopped SRS for positioning transmissions for a given occasion may be cancelled. In another example, in case of collision, only the frequency hopped SRS for positioning transmissions that overlap with other DL signals or channels or UL signals or channels may be cancelled.

In another option, within the measurement gap or SRS for positioning transmission window, if the transmission of SRS for positioning collides in time with other DL signals or channels or UL signals or channels, all symbols of SRS for positioning are cancelled, which may depend on UE capability.

In another option, whether to drop the SRS transmission for positioning may depend on periodic, semi-persistent scheduling or aperiodic SRS transmission. In one example, for periodic or semi-persistent scheduling based SRS transmission for positioning, within the measurement gap or SRS for positioning transmission window, all symbols of SRS for positioning are cancelled.

In another example, for aperiodic SRS transmission for positioning, within the measurement gap or SRS for positioning transmission window, all symbols of SRS transmission for positioning are transmitted. In this case, other DL signals/channels or UL signals/channels may be cancelled.

In another example, a UE configured with frequency hopping for SRS for positioning may be configured with measurement gap or SRS for positioning transmission window that includes all transmissions occasions across configured CCs/BWPs. Alternatively, a UE configured with frequency hopping for SRS for positioning may be configured with measurement gap or SRS for positioning transmission window that includes only the transmissions occasions across configured CCs/BWPs that are outside of the active UL BWP in the currently active serving cell.

When performing the collision handling, for DCI(s) where the time interval between the last symbol of PDCCH scheduling DL or UL channels/signals and the first transmission of SRS is at least N1 symbols/slots, the channels or signals scheduled by the DCI is considered for the collision handling. For DCI(s) where the time interval between the last symbols of PDCCH a scheduling DL or UL channels/signals and the first transmission of SRS is less than N1 symbols/slots, the channels or signals scheduled by the DCI may not be considered for the collision handling, even if the signal is high priority. The value of N1 could be predefined or up to UE capability.

In another embodiment of the invention, if a UE is expected to switch from a first to a second CC/BWP for SRS for positioning transmission with frequency hopping and any symbol of the SRS for positioning transmission in the second CC/BWP may collide with any other DL or UL channel/signal configured by higher layers or dynamically triggered/indicated/scheduled for reception or transmission in the first or second CC/BWP, the SRS for positioning may be transmitted and the DL or UL channel/signal may be dropped. This may apply for the case when the other DL or UL channel/signal may have higher priority. When the DCI triggering high priority signal is received after the UE already switches to BWP #2, the UE may stay over BWP #2 and the high priority signal may be dropped.

In one option, a common timeline may be defined for the positioning SRS, i.e., an interval of N2 symbols/slots may be defined prior to the first SRS transmission, wherein N2 could be predefined or up to UE capability. The DCI received after the time instance indicated by the N2 symbols/slots prior to the first SRS transmission may not be considered for the collision handling.

In another option, individual timeline may be defined for each SRS transmission over different CC/BWP for the position SRS, i.e., an interval of N3 symbols/slots may be defined prior to each SRS transmission, wherein N3 could be predefined or up to UE capability. The DCI received after the time instance indicated by the N3 symbols/slots prior to the SRS transmission may not be considered for the collision handling.

In another embodiment of the invention, SRS for positioning transmission window or uplink time window may be configured by higher layers via RRC signaling. In particular, the starting symbol, slot index and number of symbols or slots for the uplink time domain can be configured.

In one option, UE may request one or more uplink timing windows for activation or deactivation of SRS for positioning with frequency hopping for RedCap UEs using Medium Access Control-Control Element (MAC-CE). In this case, a new logical channel identifier (eLCID) may be defined for the request of one or more uplink time window for activation or deactivation of SRS for positioning with frequency hopping.

Table 1 below shows one example of MAC-CE for request of one uplink time window for activation or deactivation of SRS for positioning with frequency hopping for RedCap UEs. In the figure, UL timing window ID indicates the identifier for the configured UL timing window for SRS for positioning with frequency hopping for RedCap UEs. A/D field indicates activation or deactivation of UL timing window for SRS for positioning with frequency hopping. The field is set to 1 to indicate activation, otherwise it indicates deactivation. R field indicates reserved bit, which is set to 0.

TABLE 1
Medium Access Control (MAC) Control Element (CE) for
Request of Uplink Time Window for Activation or Deactivation
of SRS for Positioning with Frequency Hopping

| | | | | | |
|---|---|---|---|---|---|
| Field (One | R | R | R | A/D | UL Timing |
| Octet | | | | | Window ID |
| Total): | | | | | (4 bits) |

In another option, gNB may send activation or deactivation command for one or more uplink time window for SRS for positioning with frequency hopping for RedCap UEs using MAC-CE. In this case, a new logical channel identifier (eLCID) may be defined for the activation or deactivation command for the one or more uplink time window for SRS for positioning with frequency hopping.

Table 2 below shows a MAC-CE for activation or deactivation command of one uplink time window for SRS for positioning with frequency hopping for RedCap UEs. In the figure, UL timing window ID indicates the identifier for the configured UL timing window for SRS for positioning with frequency hopping for RedCap UEs. A/D field indicates activation or deactivation of UL timing window for SRS for positioning with frequency hopping. The field is set to 1 to indicate activation, otherwise it indicates deactivation. R field indicates reserved bit, which is set to 0.

TABLE 2
MAC-CE for Activation or Deactivation Command
of SRS for Positioning with Frequency Hopping

| | | | | | |
|---|---|---|---|---|---|
| Field (One | R | R | R | A/D | UL Timing |
| Octet | | | | | Window ID |
| Total): | | | | | (4 bits) |

In another, one or more uplink time window for positioning SRS with frequency hopping may be configured in RRC release message. In some aspects, this may apply for the case when UEs are in RRC inactive state.

Further, the above embodiments for activation and deactivation of the uplink time window can apply.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

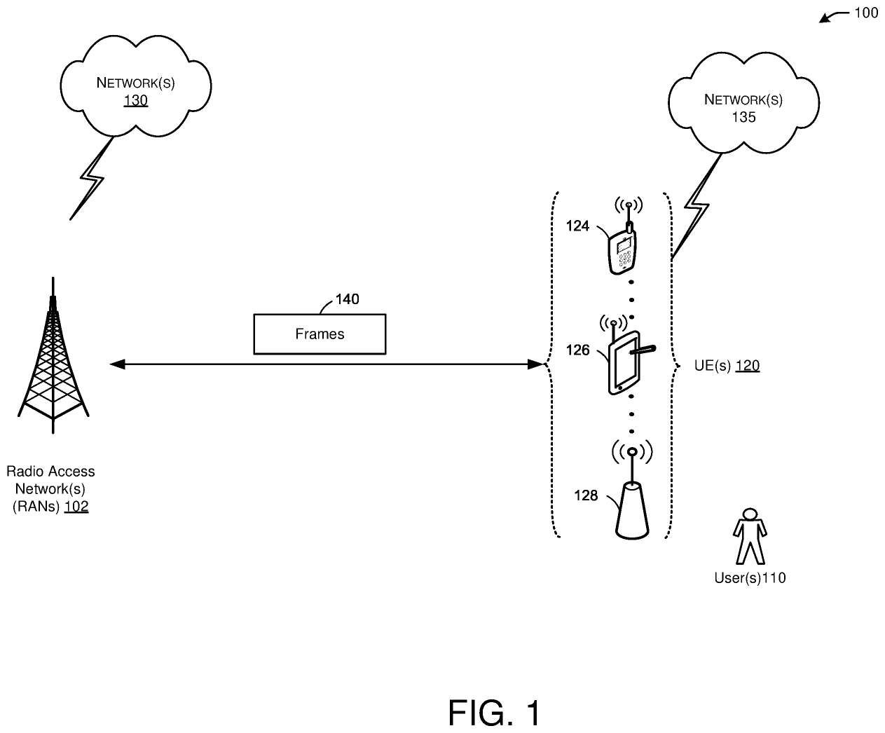

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

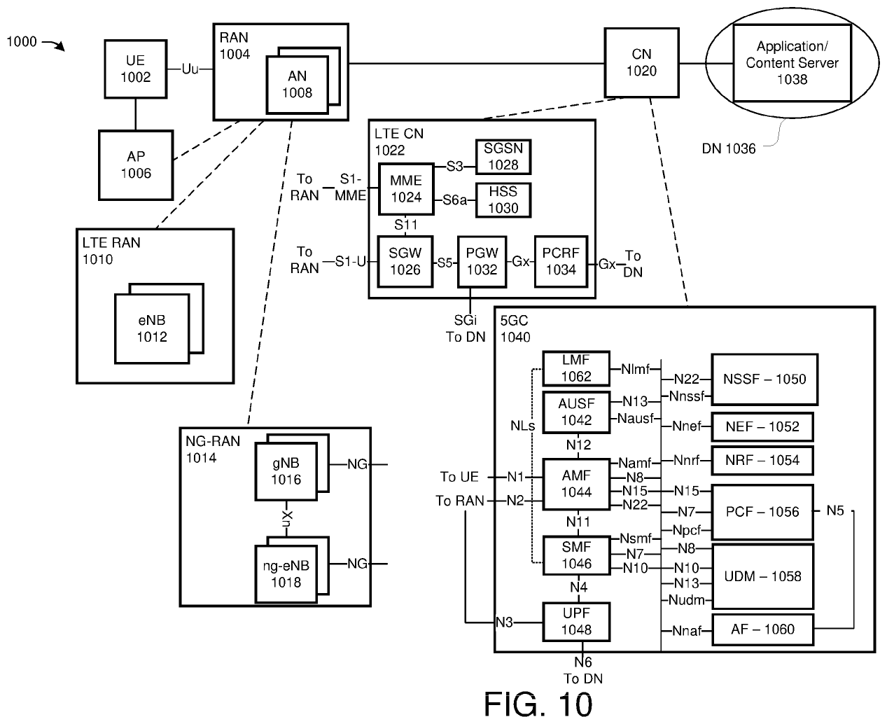

In some embodiments, the UEs 120 and the RANs 102 may include one or more computer systems similar to that of FIGS. 10-12.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QoS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UEs 120 may exchange frames 140 with the RANs 102. The frames 140 may include UL and DL frames, including signaling to configure SRS transmissions across multiple BWPs for bandwidth stitching by the receiving device, the SRS transmissions, and other transmissions as described herein.

It is understood that the above descriptions are for purposes of illustration and are not meant to be limiting.

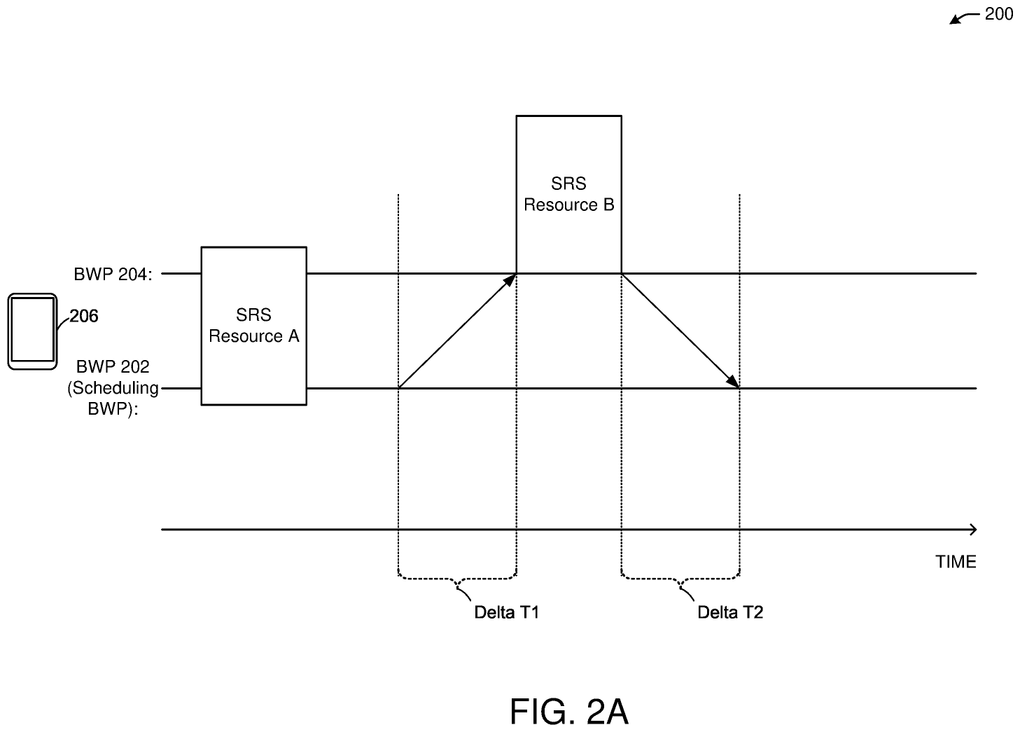

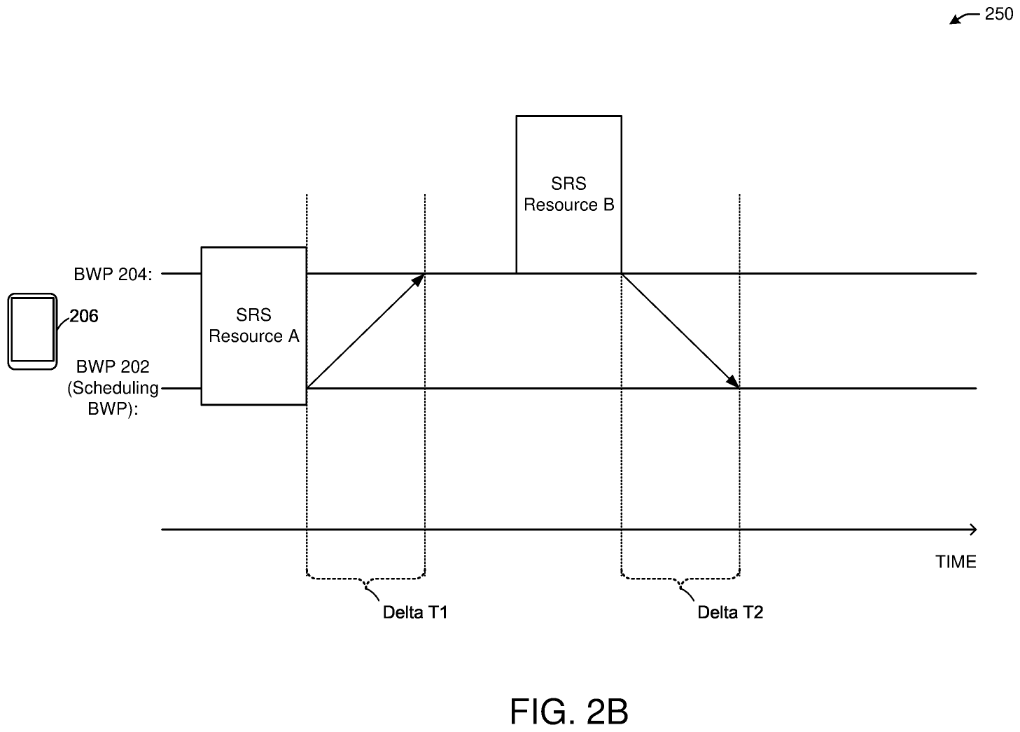

FIG. 2A illustrates an example process 200 for wireless device positioning using sounding reference signal (SRS) bandwidth stitching via multiple SRS resources for multiple different bandwidth parts (BWPs), in accordance with one or more example embodiments of the present disclosure.

Referring to FIG. 2A, BWP 202 may represent a scheduling BWP. Both the BWP 202 and a BWP 204 may be used by the UE 206 and a gNB/eNB (e.g., the RANs 102 of FIG. 1). The BWP 202 as the scheduling BWP may be the active BWP when the UE 206 transmits a SRS resource A (e.g., to the RANs 102, based on the frames 140 of FIG. 1 including a SRS defining the SRS resources to be sent across the different BWPs at different times to allow for bandwidth stitching for a positioning operation). After transmitting the SRS resource A, the UE 206 may wait a time, and then during time Δt1, the UE 206 may switch from the BWP 202 to the BWP 204. After switching to the BWP 204, the UE 206 may send a SRS resource B (e.g., to the RANs 102, based on the frames 140 of FIG. 1 including a SRS defining the SRS resources to be sent across the different BWPs at different times to allow for bandwidth stitching for a positioning operation). After sending the SRS resource B, the UE 206 may switch back to the BWP 202 during a time Δt2 (either the same as or different than Δt1). In the process 200, the gap period (e.g., dedicated to SRS resource transmissions for positioning) may begin prior to and end after completing transmission of the SRS resource B over the BWP 204. Each BWP may use one resource set for positioning.

FIG. 2B illustrates an example process 250 for wireless device positioning using SRS bandwidth stitching via multiple SRS resources for multiple different BWPs, in accordance with one or more example embodiments of the present disclosure.

Referring to FIG. 2B, BWP 202 may represent a scheduling BWP. Both the BWP 202 and a BWP 204 may be used by the UE 206 and a gNB/eNB (e.g., the RANs 102 of FIG. 1). The BWP 202 as the scheduling BWP may be the active BWP when the UE 206 transmits a SRS resource A (e.g., to the RANs 102, based on the frames 140 of FIG. 1 including a SRS defining the SRS resources to be sent across the different BWPs at different times to allow for bandwidth stitching for a positioning operation). After transmitting the SRS resource A, the UE 206 may wait a time, and then during time Δt1, the UE 206 may switch from the BWP 202 to the BWP 204. After switching to the BWP 204, the UE 206 may send a SRS resource B (e.g., to the RANs 102, based on the frames 140 of FIG. 1 including a SRS defining the SRS resources to be sent across the different BWPs at different times to allow for bandwidth stitching for a positioning operation). After sending the SRS resource B, the UE 206 may switch back to the BWP 202 during a time Δt2 (either the same as or different than Δt1). In the process 250, the gap period (e.g., dedicated to SRS resource transmissions for positioning) may begin after completing transmission of the SRS resource A over the BWP 202 and may end after the SRS resource B transmission is completed over the BWP 204. Each BWP may use one resource set for positioning.

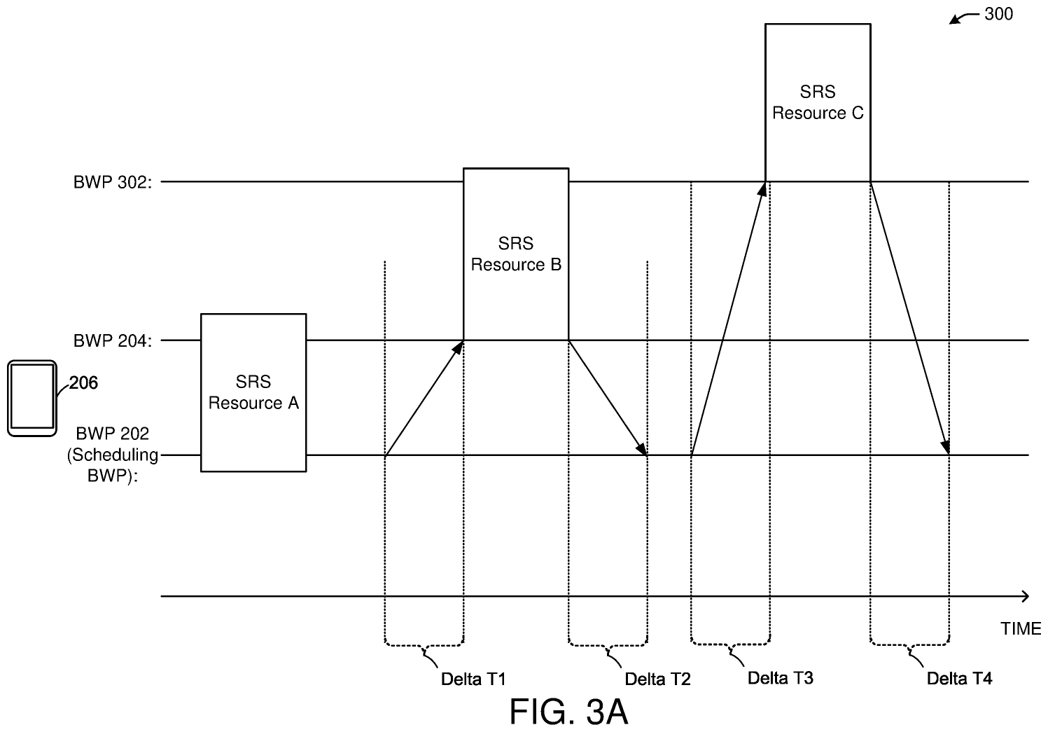

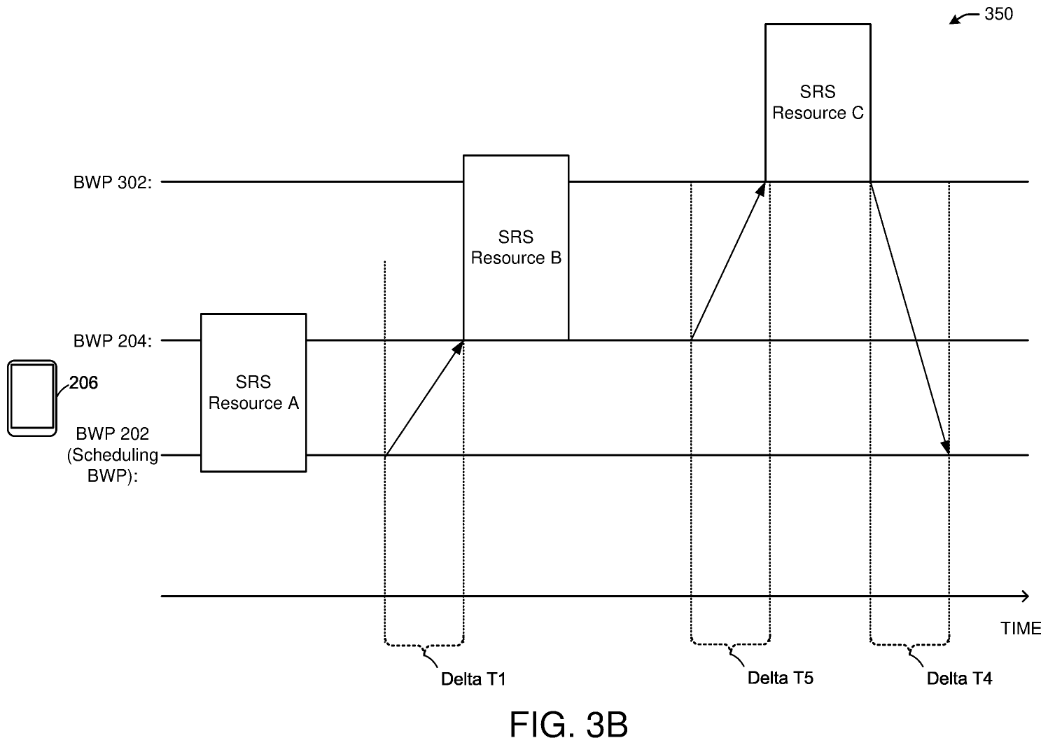

FIG. 3A illustrates an example process 300 for wireless device positioning using SRS bandwidth stitching via one SRS resource set for multiple different BWPs, in accordance with one or more example embodiments of the present disclosure.

Referring to FIG. 3A, BWP 202 may represent a scheduling BWP. The BWP 202, the BWP 204, and the BWP 302 may be used by the UE 206 and a gNB/eNB (e.g., the RANs 102 of FIG. 1). The BWP 202 as the scheduling BWP may be the active BWP when the UE 206 transmits a SRS resource A (e.g., to the RANs 102, based on the frames 140 of FIG. 1 including a SRS defining the SRS resources to be sent across the different BWPs at different times to allow for bandwidth stitching for a positioning operation). After transmitting the SRS resource A, the UE 206 may wait a time, and then during time Δt1, the UE 206 may switch from the BWP 202 to the BWP 204. After switching to the BWP 204, the UE 206 may send a SRS resource B (e.g., to the RANs 102, based on the frames 140 of FIG. 1 including a SRS defining the SRS resources to be sent across the different BWPs at different times to allow for bandwidth stitching for a positioning operation). After sending the SRS resource B, the UE 206 may switch back to the BWP 202 during a time Δt2 (either the same as or different than Δt1) before switching from BWP 202 to BWP 302 during a time Δt3. After switching to the BWP 302, the UE 206 may send SRS resource C (e.g., to the RANs 102, based on the frames 140 of FIG. 1 including a SRS defining the SRS resources to be sent across the different BWPs at different times to allow for bandwidth stitching for a positioning operation). After sending the SRS resource C, the UE 206 may switch back to the BWP 202 during a time Δt4 (either the same as or different than Δt1).

FIG. 3B illustrates an example process 350 for wireless device positioning using SRS bandwidth stitching via one SRS resource set for multiple different BWPs, in accordance with one or more example embodiments of the present disclosure.

Referring to FIG. 3B, BWP 202 may represent a scheduling BWP. The BWP 202, the BWP 204, and the BWP 302 may be used by the UE 206 and a gNB/eNB (e.g., the RANs 102 of FIG. 1). The BWP 202 as the scheduling BWP may be the active BWP when the UE 206 transmits a SRS resource A (e.g., to the RANs 102, based on the frames 140 of FIG. 1 including a SRS defining the SRS resources to be sent across the different BWPs at different times to allow for bandwidth stitching for a positioning operation). After transmitting the SRS resource A, the UE 206 may wait a time, and then during time Δt1, the UE 206 may switch from the BWP 202 to the BWP 204. After switching to the BWP 204, the UE 206 may send a SRS resource B (e.g., to the RANs 102, based on the frames 140 of FIG. 1 including a SRS defining the SRS resources to be sent across the different BWPs at different times to allow for bandwidth stitching for a positioning operation). After sending the SRS resource B, the UE 206 may switch to BWP 302 during a time Δt5. After switching to the BWP 302, the UE 206 may send SRS resource C (e.g., to the RANs 102, based on the frames 140 of FIG. 1 including a SRS defining the SRS resources to be sent across the different BWPs at different times to allow for bandwidth stitching for a positioning operation). After sending the SRS resource C, the UE 206 may switch back to the BWP 202 during the time Δt4 (either the same as or different than Δt1).

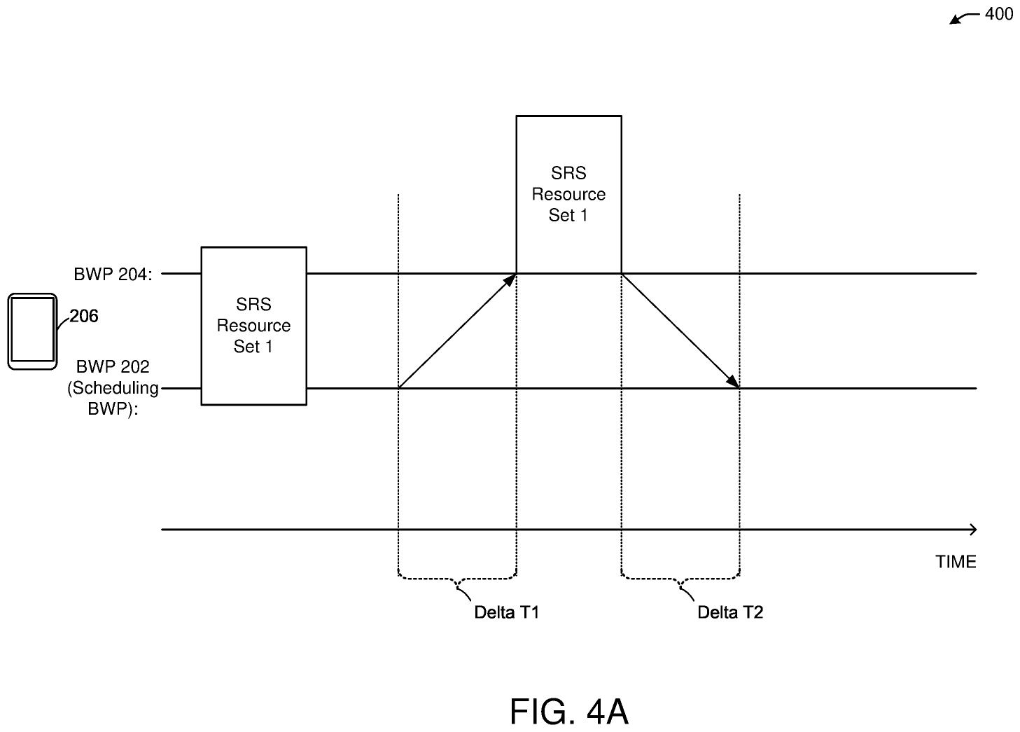

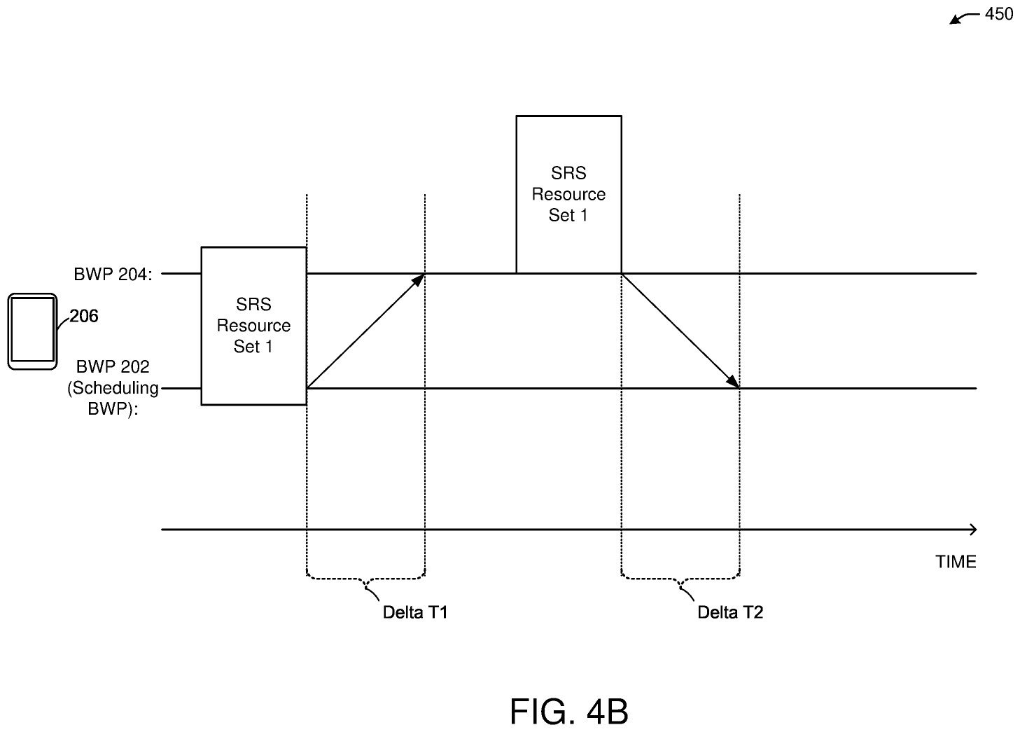

FIG. 4A illustrates an example process 400 for wireless device positioning using SRS bandwidth stitching via one SRS resource set for multiple different BWPs, in accordance with one or more example embodiments of the present disclosure.

Referring to FIG. 4A, BWP 202 may represent a scheduling BWP. Both the BWP 202 and a BWP 204 may be used by the UE 206 and a gNB/eNB (e.g., the RANs 102 of FIG. 1). The BWP 202 as the scheduling BWP may be the active BWP when the UE 206 transmits a SRS resource set 1 (e.g., to the RANs 102, based on the frames 140 of FIG. 1 including a SRS defining the SRS resources to be sent across the different BWPs at different times to allow for bandwidth stitching for a positioning operation). After transmitting the SRS resource set 1, the UE 206 may wait a time, and then during time Δt1, the UE 206 may switch from the BWP 202 to the BWP 204. After switching to the BWP 204, the UE 206 may send the SRS resource set 1 (e.g., to the RANs 102, based on the frames 140 of FIG. 1 including a SRS defining the SRS resources to be sent across the different BWPs at different times to allow for bandwidth stitching for a positioning operation). After sending the SRS resource set 1, the UE 206 may switch back to the BWP 202 during a time Δt2 (either the same as or different than Δt1). In the process 400, the gap period (e.g., dedicated to SRS resource transmissions for positioning) may begin prior to and end after completing transmission of the SRS resource B over the BWP 204.

FIG. 4B illustrates an example process 450 for wireless device positioning using SRS bandwidth stitching via one SRS resource set for multiple different BWPs, in accordance with one or more example embodiments of the present disclosure.

Referring to FIG. 4B, BWP 202 may represent a scheduling BWP. Both the BWP 202 and a BWP 204 may be used by the UE 206 and a gNB/eNB (e.g., the RANs 102 of FIG. 1). The BWP 202 as the scheduling BWP may be the active BWP when the UE 206 transmits a SRS resource set 1 (e.g., to the RANs 102, based on the frames 140 of FIG. 1 including a SRS defining the SRS resources to be sent across the different BWPs at different times to allow for bandwidth stitching for a positioning operation). After transmitting the SRS resource set 1, during time Δt1, the UE 206 may switch from the BWP 202 to the BWP 204. After switching to the BWP 204, the UE 206 may send the SRS resource set 1 (e.g., to the RANs 102, based on the frames 140 of FIG. 1 including a SRS defining the SRS resources to be sent across the different BWPs at different times to allow for bandwidth stitching for a positioning operation). After sending the SRS resource set 1, the UE 206 may switch back to the BWP 202 during a time Δt2 (either the same as or different than Δt1). In the process 450, the gap period (e.g., dedicated to SRS resource transmissions for positioning) may begin prior to and end after completing transmission of the SRS resource B over the BWP 204.

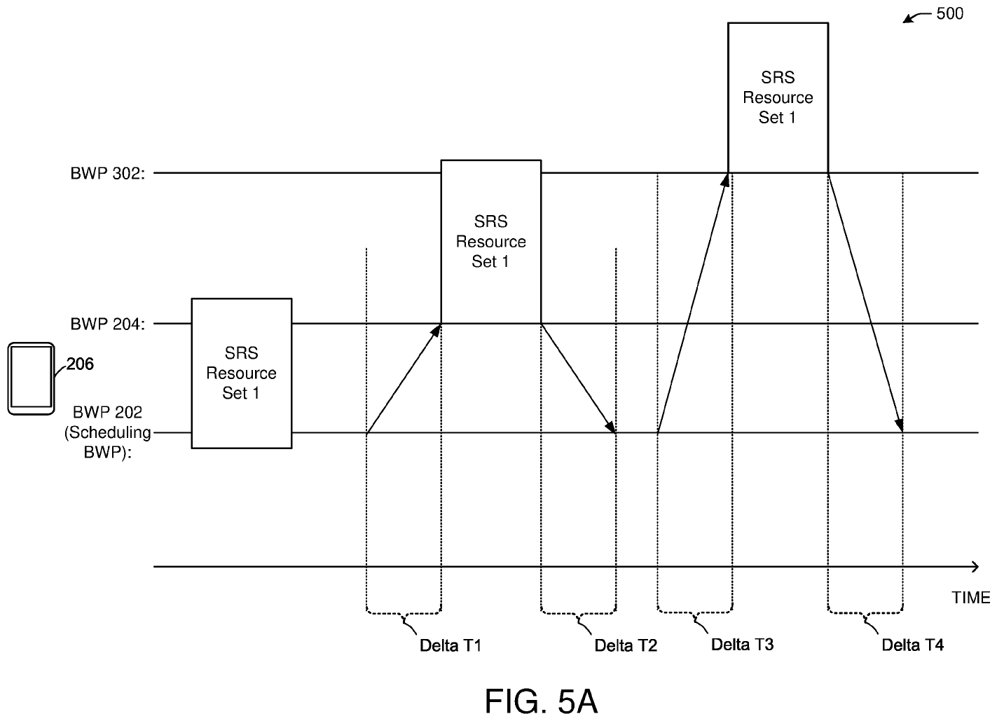

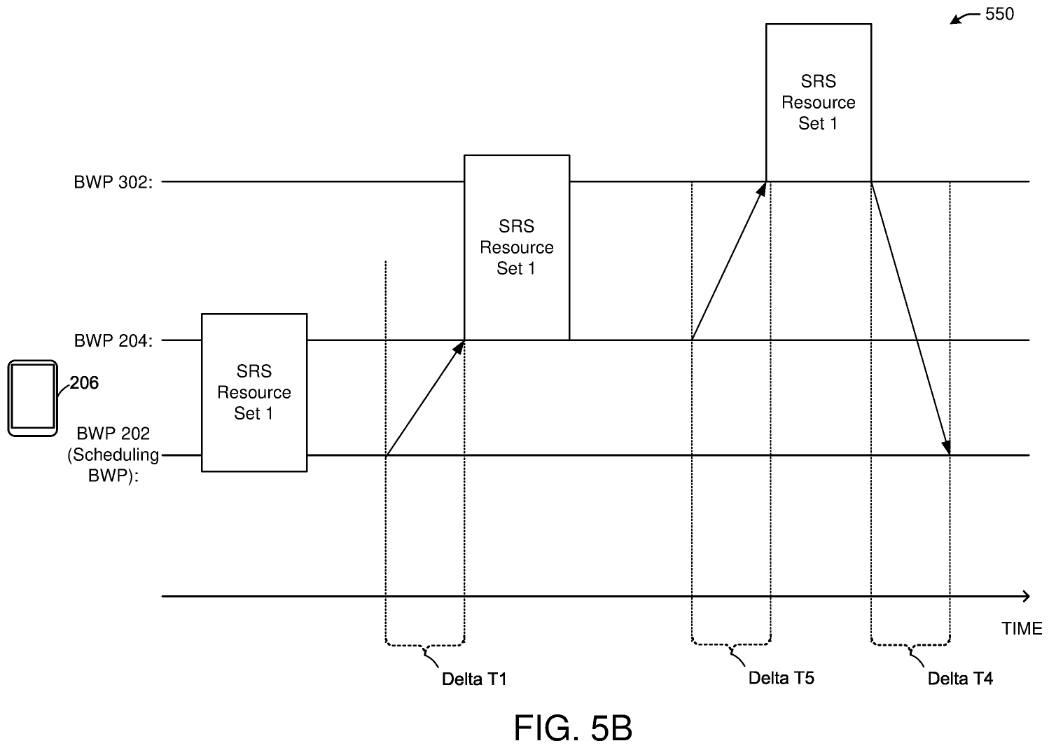

FIG. 5A illustrates an example process 500 for wireless device positioning using SRS bandwidth stitching via one SRS resource set for multiple different BWPs, in accordance with one or more example embodiments of the present disclosure.

Referring to FIG. 5A, BWP 202 may represent a scheduling BWP. The BWP 202, the BWP 204, and the BWP 302 may be used by the UE 206 and a gNB/eNB (e.g., the RANs 102 of FIG. 1). The BWP 202 as the scheduling BWP may be the active BWP when the UE 206 transmits a SRS resource set 1 (e.g., to the RANs 102, based on the frames 140 of FIG. 1 including a SRS defining the SRS resources to be sent across the different BWPs at different times to allow for bandwidth stitching for a positioning operation). After transmitting the SRS resource set 1, the UE 206 may wait a time, and then during time Δt1, the UE 206 may switch from the BWP 202 to the BWP 204. After switching to the BWP 204, the UE 206 may send the SRS resource set 1 (e.g., to the RANs 102, based on the frames 140 of FIG. 1 including a SRS defining the SRS resources to be sent across the different BWPs at different times to allow for bandwidth stitching for a positioning operation). After sending the SRS resource set 1, the UE 206 may switch back to the BWP 202 during a time Δt2 (either the same as or different than Δt1) before switching from BWP 202 to BWP 302 during a time Δt3. After switching to the BWP 302, the UE 206 may send the SRS resource set 1 (e.g., to the RANs 102, based on the frames 140 of FIG. 1 including a SRS defining the SRS resources to be sent across the different BWPs at different times to allow for bandwidth stitching for a positioning operation). After sending the SRS resource set 1, the UE 206 may switch back to the BWP 202 during a time Δt4 (either the same as or different than Δt1).

FIG. 5B illustrates an example process 550 for wireless device positioning using SRS bandwidth stitching via one SRS resource set for multiple different BWPs, in accordance with one or more example embodiments of the present disclosure.

Referring to FIG. 5B, BWP 202 may represent a scheduling BWP. The BWP 202, the BWP 204, and the BWP 302 may be used by the UE 206 and a gNB/eNB (e.g., the RANs 102 of FIG. 1). The BWP 202 as the scheduling BWP may be the active BWP when the UE 206 transmits a SRS resource set 1 (e.g., to the RANs 102, based on the frames 140 of FIG. 1 including a SRS defining the SRS resources to be sent across the different BWPs at different times to allow for bandwidth stitching for a positioning operation). After transmitting the SRS resource set 1, the UE 206 may wait a time, and then during time Δt1, the UE 206 may switch from the BWP 202 to the BWP 204. After switching to the BWP 204, the UE 206 may send the SRS resource set 1 (e.g., to the RANs 102, based on the frames 140 of FIG. 1 including a SRS defining the SRS resources to be sent across the different BWPs at different times to allow for bandwidth stitching for a positioning operation). After sending the SRS resource set 1, the UE 206 may switch to BWP 302 during a time Δt5. After switching to the BWP 302, the UE 206 may send the SRS resource set 1 (e.g., to the RANs 102, based on the frames 140 of FIG. 1 including a SRS defining the SRS resources to be sent across the different BWPs at different times to allow for bandwidth stitching for a positioning operation). After sending the SRS resource set 1, the UE 206 may switch back to the BWP 202 during the time Δt4 (either the same as or different than Δt1).

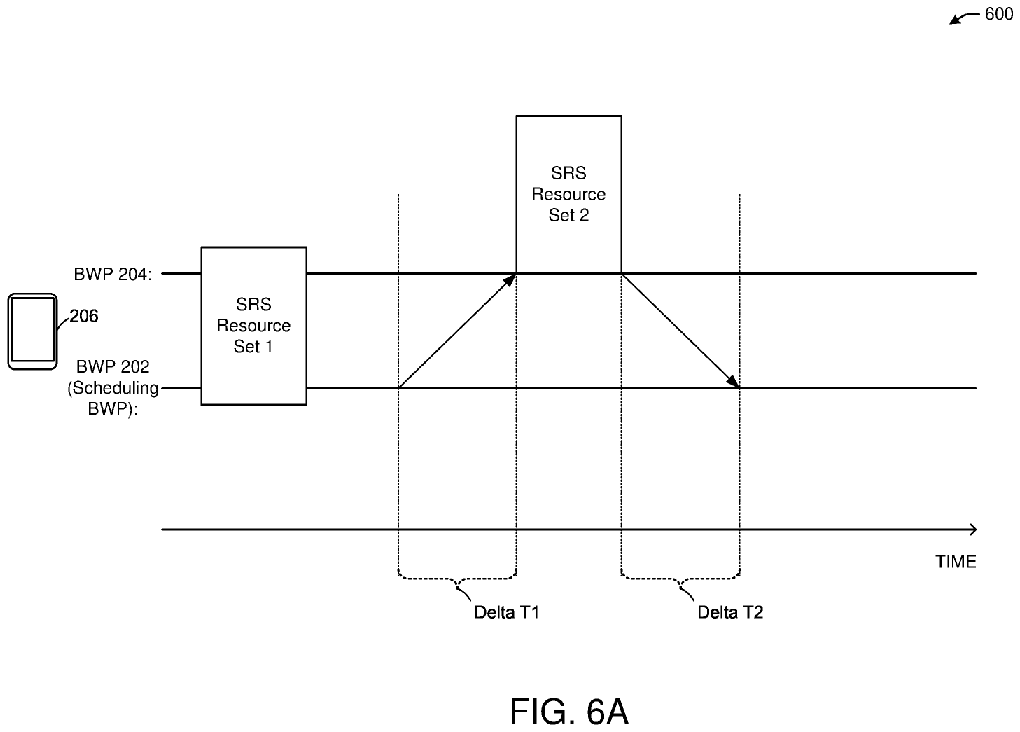

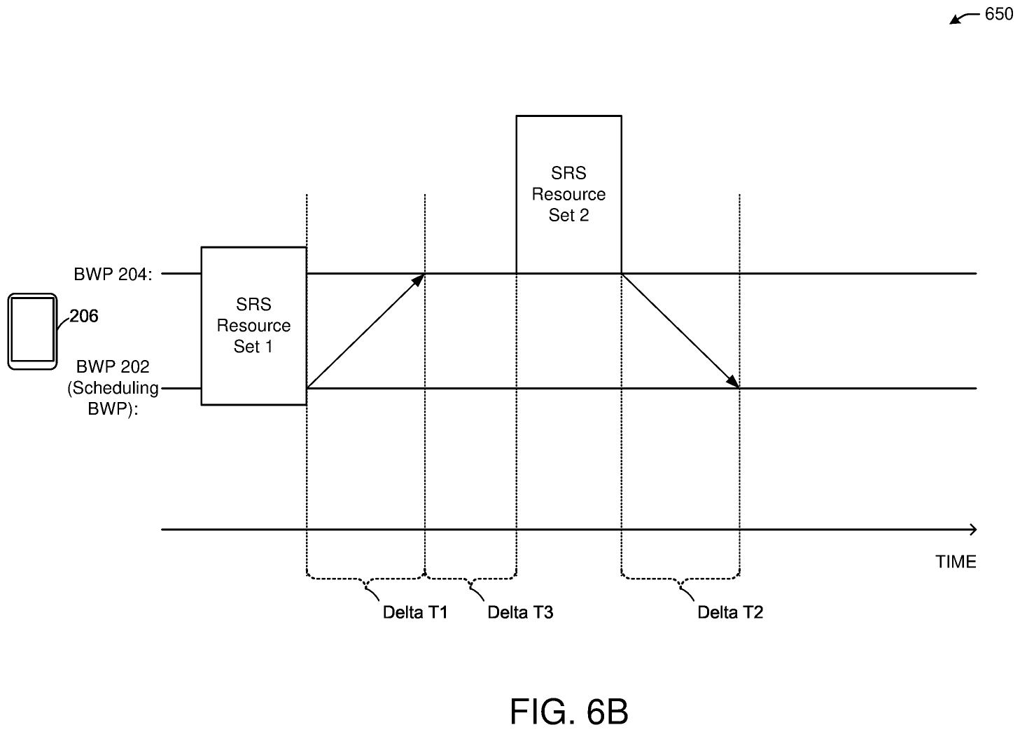

FIG. 6A illustrates an example process 600 for wireless device positioning using SRS bandwidth stitching via SRS resource sets for multiple different BWPs, in accordance with one or more example embodiments of the present disclosure.

Referring to FIG. 6A, BWP 202 may represent a scheduling BWP. Both the BWP 202 and a BWP 204 may be used by the UE 206 and a gNB/eNB (e.g., the RANs 102 of FIG. 1). The BWP 202 as the scheduling BWP may be the active BWP when the UE 206 transmits a SRS resource set 1 (e.g., to the RANs 102, based on the frames 140 of FIG. 1 including a SRS defining the SRS resources to be sent across the different BWPs at different times to allow for bandwidth stitching for a positioning operation). After transmitting the SRS resource A, the UE 206 may wait a time, and then during time Δt1, the UE 206 may switch from the BWP 202 to the BWP 204. After switching to the BWP 204, the UE 206 may send a SRS resource set 2 (e.g., to the RANs 102, based on the frames 140 of FIG. 1 including a SRS defining the SRS resources to be sent across the different BWPs at different times to allow for bandwidth stitching for a positioning operation). After sending the SRS resource set 2, the UE 206 may switch back to the BWP 202 during a time Δt2 (either the same as or different than Δt1). In the process 600, the gap period (e.g., dedicated to SRS resource transmissions for positioning) may begin prior to and end after completing transmission of the SRS resource set 2 over the BWP 204.

FIG. 6B illustrates an example process 650 for wireless device positioning using SRS bandwidth stitching via SRS resource sets for multiple different BWPs, in accordance with one or more example embodiments of the present disclosure.

Referring to FIG. 6B, BWP 202 may represent a scheduling BWP. Both the BWP 202 and a BWP 204 may be used by the UE 206 and a gNB/eNB (e.g., the RANs 102 of FIG. 1). The BWP 202 as the scheduling BWP may be the active BWP when the UE 206 transmits a SRS resource set 1 (e.g., to the RANs 102, based on the frames 140 of FIG. 1 including a SRS defining the SRS resources to be sent across the different BWPs at different times to allow for bandwidth stitching for a positioning operation). After transmitting the SRS resource A, the UE 206 may wait a time, and then during time Δt1, the UE 206 may switch from the BWP 202 to the BWP 204 during a time Δt3. After switching to the BWP 204, the UE 206 may send a SRS resource set 2 (e.g., to the RANs 102, based on the frames 140 of FIG. 1 including a SRS defining the SRS resources to be sent across the different BWPs at different times to allow for bandwidth stitching for a positioning operation). After sending the SRS resource set 2, the UE 206 may switch back to the BWP 202 during a time Δt2 (either the same as or different than Δt1). In the process 650, the gap period (e.g., dedicated to SRS resource transmissions for positioning) may begin after completing transmission of the SRS resource A over the BWP 202 and may end after the SRS resource set 2 transmission is completed over the BWP 204.

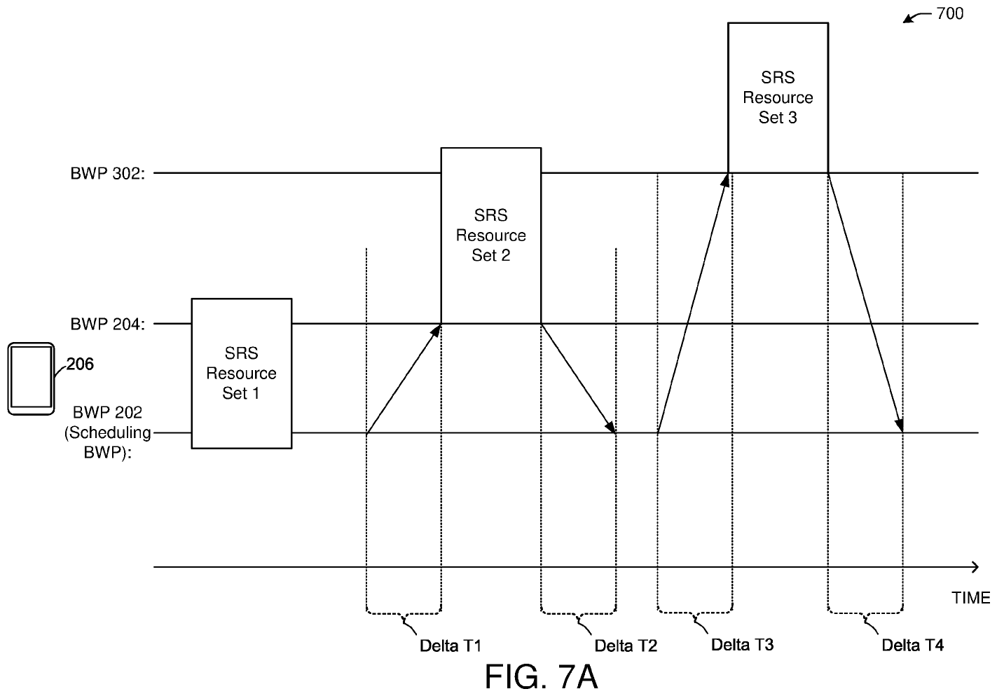

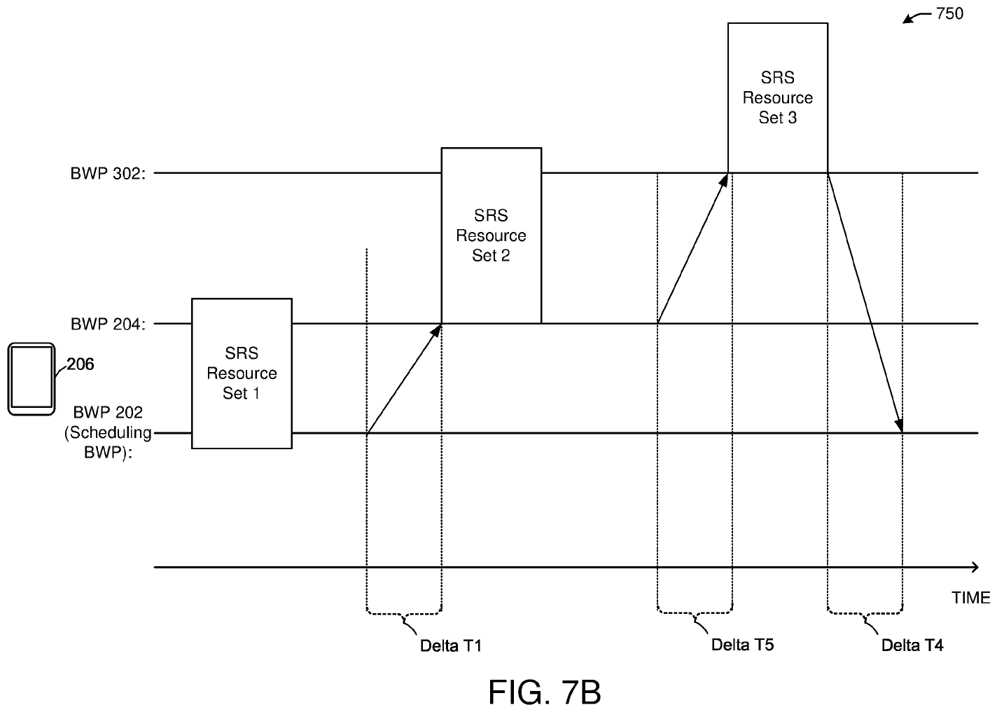

FIG. 7A illustrates an example process 700 for wireless device positioning using SRS bandwidth stitching via SRS resource sets for multiple different BWPs, in accordance with one or more example embodiments of the present disclosure.

Referring to FIG. 7A, BWP 202 may represent a scheduling BWP. The BWP 202, the BWP 204, and the BWP 302 may be used by the UE 206 and a gNB/eNB (e.g., the RANs 102 of FIG. 1). The BWP 202 as the scheduling BWP may be the active BWP when the UE 206 transmits a SRS resource set 1 (e.g., to the RANs 102, based on the frames 140 of FIG. 1 including a SRS defining the SRS resources to be sent across the different BWPs at different times to allow for bandwidth stitching for a positioning operation). After transmitting the SRS resource set 1, the UE 206 may wait a time, and then during time Δt1, the UE 206 may switch from the BWP 202 to the BWP 204. After switching to the BWP 204, the UE 206 may send a SRS resource set 2 (e.g., to the RANs 102, based on the frames 140 of FIG. 1 including a SRS defining the SRS resources to be sent across the different BWPs at different times to allow for bandwidth stitching for a positioning operation). After sending the SRS resource set 2, the UE 206 may switch back to the BWP 202 during a time Δt2 (either the same as or different than Δt1) before switching from BWP 202 to BWP 302 during a time Δt3. After switching to the BWP 302, the UE 206 may send SRS resource set 3 (e.g., to the RANs 102, based on the frames 140 of FIG. 1 including a SRS defining the SRS resources to be sent across the different BWPs at different times to allow for bandwidth stitching for a positioning operation). After sending the SRS resource set 3, the UE 206 may switch back to the BWP 202 during a time Δt4 (either the same as or different than Δt1).

FIG. 7B illustrates an example process 750 for wireless device positioning using SRS bandwidth stitching via SRS resource sets for multiple different BWPs, in accordance with one or more example embodiments of the present disclosure.

Referring to FIG. 7B, BWP 202 may represent a scheduling BWP. The BWP 202, the BWP 204, and the BWP 302 may be used by the UE 206 and a gNB/eNB (e.g., the RANs 102 of FIG. 1). The BWP 202 as the scheduling BWP may be the active BWP when the UE 206 transmits a SRS resource set 1 (e.g., to the RANs 102, based on the frames 140 of FIG. 1 including a SRS defining the SRS resources to be sent across the different BWPs at different times to allow for bandwidth stitching for a positioning operation). After transmitting the SRS resource set 1, the UE 206 may wait a time, and then during time Δt1, the UE 206 may switch from the BWP 202 to the BWP 204. After switching to the BWP 204, the UE 206 may send a SRS resource set 2 (e.g., to the RANs 102, based on the frames 140 of FIG. 1 including a SRS defining the SRS resources to be sent across the different BWPs at different times to allow for bandwidth stitching for a positioning operation). After sending the SRS resource set 2, the UE 206 may switch to BWP 302 during a time Δt5. After switching to the BWP 302, the UE 206 may send SRS resource set 3 (e.g., to the RANs 102, based on the frames 140 of FIG. 1 including a SRS defining the SRS resources to be sent across the different BWPs at different times to allow for bandwidth stitching for a positioning operation). After sending the SRS resource set 3, the UE 206 may switch back to the BWP 202 during the time Δt4 (either the same as or different than Δt1).

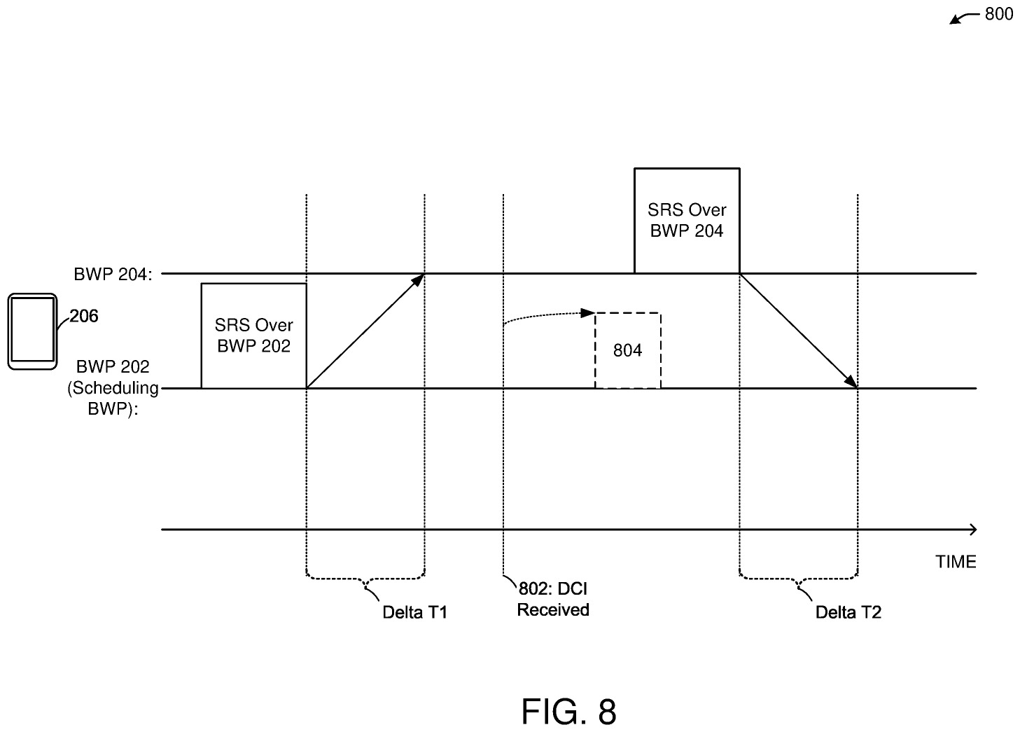

FIG. 8 illustrates an example process 800 for wireless device positioning with SRS collision handling, in accordance with one or more example embodiments of the present disclosure.

Referring to FIG. 8, the UE 206 may send SRS over the BWP 202, and then during time Δt1 may switch to the BWP 204. At step 802, DCI (e.g., which may trigger a high-priority signal 804) may be received by the UE on the BWP 202. When the high priority signal 804 is to be transmitted during any symbol of SRS to be transmitted (e.g., on BWP 204), the UE 206 may drop (e.g., cancel transmission of) the high priority signal 804. After transmitting the SRS over BWP 204, the UE 206 may switch back to the BWP 202 during the time Δt2.

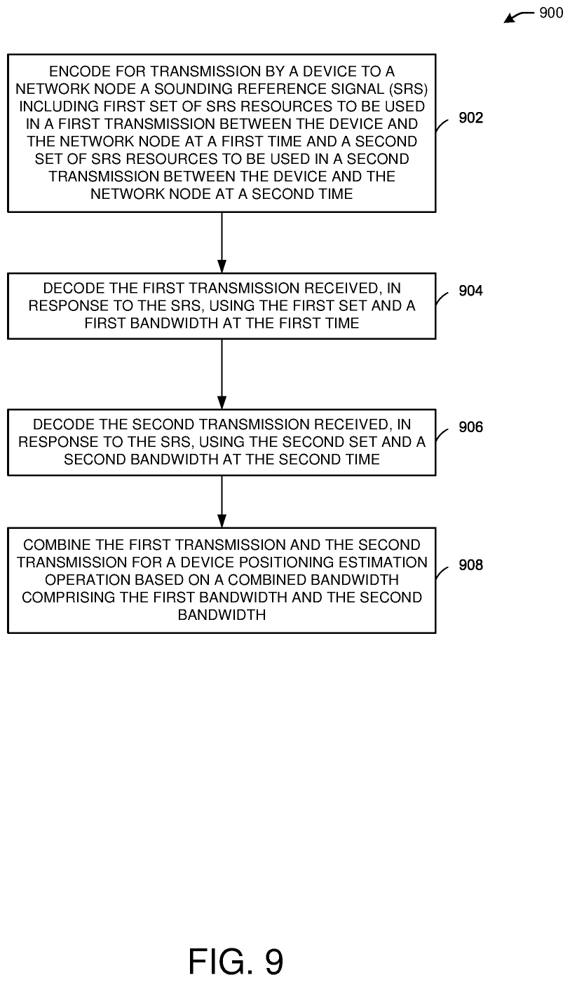

FIG. 9 illustrates a flow diagram of illustrative process 900 for wireless device positioning using SRS bandwidth stitching via multiple SRS resources for multiple different BWPs, in accordance with one or more example embodiments of the present disclosure.

At block 902, a device (e.g., the UE devices 120 of FIG. 1, the UE 1002 of FIG. 10, which may be a RedCap UE), may encode for transmission to a network node a sounding reference signal (SRS) including a first set of SRS resources to be used in a first transmission between the UE device and the node B network device at a first time and a second set of SRS resources to be used in a second transmission between the UE device and the node B network device at a second time.

At block 904, the device may decode the first transmission received, in response to the SRS, using the first set of SRS resources and a first bandwidth at the first time.

At block 906, the device may decode the second transmission received, in response to the SRS, using the second set of SRS resources and a second bandwidth at the second time, wherein the first bandwidth partially overlaps the second bandwidth. When the SRS includes resources for additional bandwidth (e.g., BWPs), the UE may transmit additional SRS transmissions over the additional bandwidth to be used in a positioning operation with the first and second transmissions.

At block 908, the device may combine the first transmission and the second transmission (and any other SRS transmissions from the UE over a contiguous bandwidth) for a device positioning estimation operation based on a combined bandwidth comprising the first bandwidth and the second bandwidth. In this manner, the device may use bandwidth stitching for the transmissions over different portions of contiguous bandwidth to perform channel estimation across the combined contiguous bandwidth in a positioning (e.g., estimation of device position) operation.

These embodiments are not meant to be limiting.

FIG. 10 illustrates a network 1000 in accordance with various embodiments. The network 1000 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1000 may include a UE 1002, which may include any mobile or non-mobile computing device designed to communicate with a RAN 1004 via an over-the-air connection. The UE 1002 may be communicatively coupled with the RAN 1004 by a Uu interface. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1002 may additionally communicate with an AP 1006 via an over-the-air connection. The AP 1006 may manage a WLAN connection, which may serve to offload some/all network traffic from the RAN 1004. The connection between the UE 1002 and the AP 1006 may be consistent with any IEEE 802.11 protocol, wherein the AP 1006 could be a wireless fidelity (Wi-Fi®) router. In some embodiments, the UE 1002, RAN 1004, and AP 1006 may utilize cellular-WLAN aggregation (for example, LWA/LWIP). Cellular-WLAN aggregation may involve the UE 1002 being configured by the RAN 1004 to utilize both cellular radio resources and WLAN resources.

The RAN 1004 may include one or more access nodes, for example, AN 1008. AN 1008 may terminate air-interface protocols for the UE 1002 by providing access stratum protocols including RRC, PDCP, RLC, MAC, and L1 protocols. In this manner, the AN 1008 may enable data/voice connectivity between CN 1020 and the UE 1002. In some embodiments, the AN 1008 may be implemented in a discrete device or as one or more software entities running on server computers as part of, for example, a virtual network, which may be referred to as a CRAN or virtual baseband unit pool. The AN 1008 be referred to as a BS, gNB, RAN node, eNB, ng-eNB, NodeB, RSU, TRxP, TRP, etc. The AN 1008 may be a macrocell base station or a low power base station for providing femtocells, picocells or other like cells having smaller coverage areas, smaller user capacity, or higher bandwidth compared to macrocells.

In embodiments in which the RAN 1004 includes a plurality of ANs, they may be coupled with one another via an X2 interface (if the RAN 1004 is an LTE RAN) or an Xn interface (if the RAN 1004 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1004 may each manage one or more cells, cell groups, component carriers, etc. to provide the UE 1002 with an air interface for network access. The UE 1002 may be simultaneously connected with a plurality of cells provided by the same or different ANs of the RAN 1004. For example, the UE 1002 and RAN 1004 may use carrier aggregation to allow the UE 1002 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1004 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1002 or AN 1008 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1004 may be an LTE RAN 1010 with eNBs, for example, eNB 1012. The LTE RAN 1010 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1004 may be an NG-RAN 1014 with gNBs, for example, gNB 1016, or ng-eNBs, for example, ng-eNB 1018. The gNB 1016 may connect with 5G-enabled UEs using a 5G NR interface. The gNB 1016 may connect with a 5G core through an NG interface, which may include an N2 interface or an N3 interface. The ng-eNB 1018 may also connect with the 5G core through an NG interface, but may connect with a UE via an LTE air interface. The gNB 1016 and the ng-eNB 1018 may connect with each other over an Xn interface.

In some embodiments, the NG interface may be split into two parts, an NG user plane (NG-U) interface, which carries traffic data between the nodes of the NG-RAN 1014 and a UPF 1048 (e.g., N3 interface), and an NG control plane (NG-C) interface, which is a signaling interface between the nodes of the NG-RAN 1014 and an AMF 1044 (e.g., N2 interface).

The NG-RAN 1014 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1002 can be configured with multiple BWPs where each BWP configuration has a different SCS. When a BWP change is indicated to the UE 1002, the SCS of the transmission is changed as well. Another use case example of BWP is related to power saving. In particular, multiple BWPs can be configured for the UE 1002 with different amount of frequency resources (for example, PRBs) to support data transmission under different traffic loading scenarios. A BWP containing a smaller number of PRBs can be used for data transmission with small traffic load while allowing power saving at the UE 1002 and in some cases at the gNB 1016. A BWP containing a larger number of PRBs can be used for scenarios with higher traffic load.

The RAN 1004 is communicatively coupled to CN 1020 that includes network elements to provide various functions to support data and telecommunications services to customers/subscribers (for example, users of UE 1002). The components of the CN 1020 may be implemented in one physical node or separate physical nodes. In some embodiments, NFV may be utilized to virtualize any or all of the functions provided by the network elements of the CN 1020 onto physical compute/storage resources in servers, switches, etc. A logical instantiation of the CN 1020 may be referred to as a network slice, and a logical instantiation of a portion of the CN 1020 may be referred to as a network sub-slice.

In some embodiments, the CN 1020 may be an LTE CN 1022, which may also be referred to as an EPC. The LTE CN 1022 may include MME 1024, SGW 1026, SGSN 1028, HSS 1030, PGW 1032, and PCRF 1034 coupled with one another over interfaces (or “reference points”) as shown. Functions of the elements of the LTE CN 1022 may be briefly introduced as follows.

The MME 1024 may implement mobility management functions to track a current location of the UE 1002 to facilitate paging, bearer activation/deactivation, handovers, gateway selection, authentication, etc.

The SGW 1026 may terminate an S1 interface toward the RAN and route data packets between the RAN and the LTE CN 1022. The SGW 1026 may be a local mobility anchor point for inter-RAN node handovers and also may provide an anchor for inter-3GPP mobility. Other responsibilities may include lawful intercept, charging, and some policy enforcement.

The SGSN 1028 may track a location of the UE 1002 and perform security functions and access control. In addition, the SGSN 1028 may perform inter-EPC node signaling for mobility between different RAT networks; PDN and S-GW selection as specified by MME 1024; MME selection for handovers; etc. The S3 reference point between the MME 424 and the SGSN 1028 may enable user and bearer information exchange for inter-3GPP access network mobility in idle/active states.

The HSS 1030 may include a database for network users, including subscription-related information to support the network entities' handling of communication sessions. The HSS 1030 can provide support for routing/roaming, authentication, authorization, naming/addressing resolution, location dependencies, etc. An S6a reference point between the HSS 1030 and the MME 1024 may enable transfer of subscription and authentication data for authenticating/authorizing user access to the LTE CN 1020.

The PGW 1032 may terminate an SGi interface toward a data network (DN) 1036 that may include an application/content server 1038. The PGW 1032 may route data packets between the LTE CN 1022 and the data network 1036. The PGW 1032 may be coupled with the SGW 1026 by an S5 reference point to facilitate user plane tunneling and tunnel management. The PGW 1032 may further include a node for policy enforcement and charging data collection (for example, PCEF). Additionally, the SGi reference point between the PGW 1032 and the data network 1036 may be an operator external public, a private PDN, or an intra-operator packet data network, for example, for provision of IMS services. The PGW 1032 may be coupled with a PCRF 1034 via a Gx reference point.

The PCRF 1034 is the policy and charging control element of the LTE CN 1022. The PCRF 1034 may be communicatively coupled to the app/content server 1038 to determine appropriate QoS and charging parameters for service flows. The PCRF 1032 may provision associated rules into a PCEF (via Gx reference point) with appropriate TFT and QCI.

In some embodiments, the CN 1020 may be a 5GC 1040. The 5GC 1040 may include an AUSF 1042, AMF 1044, SMF 1046, UPF 1048, NSSF 1050, NEF 1052, NRF 1054, PCF 1056, UDM 1058, and AF 1060 coupled with one another over interfaces (or “reference points”) as shown. Functions of the elements of the 5GC 1040 may be briefly introduced as follows.

The AUSF 1042 may store data for authentication of UE 1002 and handle authentication-related functionality. The AUSF 1042 may facilitate a common authentication framework for various access types. In addition to communicating with other elements of the 5GC 1040 over reference points as shown, the AUSF 1042 may exhibit an Nausf service-based interface.

The AMF 1044 may allow other functions of the 5GC 1040 to communicate with the UE 1002 and the RAN 1004 and to subscribe to notifications about mobility events with respect to the UE 1002. The AMF 1044 may be responsible for registration management (for example, for registering UE 1002), connection management, reachability management, mobility management, lawful interception of AMF-related events, and access authentication and authorization. The AMF 1044 may provide transport for SM messages between the UE 1002 and the SMF 1046, and act as a transparent proxy for routing SM messages. AMF 1044 may also provide transport for SMS messages between UE 1002 and an SMSF. AMF 1044 may interact with the AUSF 1042 and the UE 1002 to perform various security anchor and context management functions. Furthermore, AMF 1044 may be a termination point of a RAN CP interface, which may include or be an N2 reference point between the RAN 1004 and the AMF 1044; and the AMF 1044 may be a termination point of NAS (N1) signaling, and perform NAS ciphering and integrity protection. AMF 1044 may also support NAS signaling with the UE 1002 over an N3 IWF interface.

The SMF 1046 may be responsible for SM (for example, session establishment, tunnel management between UPF 1048 and AN 1008); UE IP address allocation and management (including optional authorization); selection and control of UP function; configuring traffic steering at UPF 1048 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1044 over N2 to AN 1008; and determining SSC mode of a session. SM may refer to management of a PDU session, and a PDU session or “session” may refer to a PDU connectivity service that provides or enables the exchange of PDUs between the UE 1002 and the data network 1036.

The UPF 1048 may act as an anchor point for intra-RAT and inter-RAT mobility, an external PDU session point of interconnect to data network 1036, and a branching point to support multi-homed PDU session. The UPF 1048 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1048 may include an uplink classifier to support routing traffic flows to a data network.

The NSSF 1050 may select a set of network slice instances serving the UE 1002. The NSSF 1050 may also determine allowed NSSAI and the mapping to the subscribed S-NSSAIs, if needed. The NSSF 1050 may also determine the AMF set to be used to serve the UE 1002, or a list of candidate AMFs based on a suitable configuration and possibly by querying the NRF 1054. The selection of a set of network slice instances for the UE 1002 may be triggered by the AMF 1044 with which the UE 1002 is registered by interacting with the NSSF 1050, which may lead to a change of AMF. The NSSF 1050 may interact with the AMF 1044 via an N22 reference point; and may communicate with another NSSF in a visited network via an N31 reference point (not shown). Additionally, the NSSF 1050 may exhibit an Nnssf service-based interface.

The NEF 1052 may securely expose services and capabilities provided by 3GPP network functions for third party, internal exposure/re-exposure, AFs (e.g., AF 1060), edge computing or fog computing systems, etc. In such embodiments, the NEF 1052 may authenticate, authorize, or throttle the AFs. NEF 1052 may also translate information exchanged with the AF 1060 and information exchanged with internal network functions. For example, the NEF 1052 may translate between an AF-Service-Identifier and an internal 5GC information. NEF 1052 may also receive information from other NFs based on exposed capabilities of other NFs. This information may be stored at the NEF 1052 as structured data, or at a data storage NF using standardized interfaces. The stored information can then be re-exposed by the NEF 1052 to other NFs and AFs, or used for other purposes such as analytics. Additionally, the NEF 1052 may exhibit an Nnef service-based interface.

The NRF 1054 may support service discovery functions, receive NF discovery requests from NF instances, and provide the information of the discovered NF instances to the NF instances. NRF 1054 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1054 may exhibit the Nnrf service-based interface.

The PCF 1056 may provide policy rules to control plane functions to enforce them, and may also support unified policy framework to govern network behavior. The PCF 1056 may also implement a front end to access subscription information relevant for policy decisions in a UDR of the UDM 1058. In addition to communicating with functions over reference points as shown, the PCF 1056 exhibit an Npcf service-based interface.

The UDM 1058 may handle subscription-related information to support the network entities' handling of communication sessions, and may store subscription data of UE 1002. For example, subscription data may be communicated via an N8 reference point between the UDM 1058 and the AMF 1044. The UDM 1058 may include two parts, an application front end and a UDR. The UDR may store subscription data and policy data for the UDM 1058 and the PCF 1056, and/or structured data for exposure and application data (including PFDs for application detection, application request information for multiple UEs 1002) for the NEF 1052. The Nudr service-based interface may be exhibited by the UDR to allow the UDM 1058, PCF 1056, and NEF 1052 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1058 may exhibit the Nudm service-based interface.

The AF 1060 may provide application influence on traffic routing, provide access to NEF, and interact with the policy framework for policy control.

In some embodiments, the 5GC 1040 may enable edge computing by selecting operator/3^{rd} party services to be geographically close to a point that the UE 1002 is attached to the network. This may reduce latency and load on the network. To provide edge-computing implementations, the 5GC 1040 may select a UPF 1048 close to the UE 1002 and execute traffic steering from the UPF 1048 to data network 1036 via the N6 interface. This may be based on the UE subscription data, UE location, and information provided by the AF 1060. In this way, the AF 1060 may influence UPF (re)selection and traffic routing. Based on operator deployment, when AF 1060 is considered to be a trusted entity, the network operator may permit AF 1060 to interact directly with relevant NFs. Additionally, the AF 1060 may exhibit an Naf service-based interface.

The data network 1036 may represent various network operator services, Internet access, or third party services that may be provided by one or more servers including, for example, application/content server 1038.

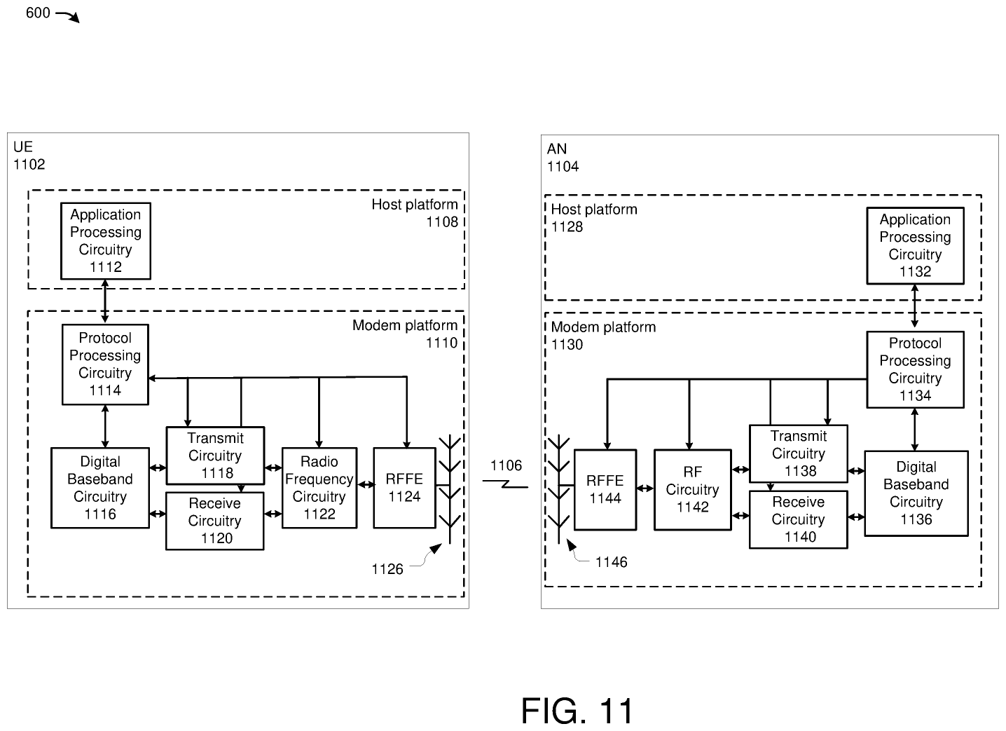

FIG. 11 schematically illustrates a wireless network 1100 in accordance with various embodiments. The wireless network 1100 may include a UE 1102 in wireless communication with an AN 1104. The UE 1102 and AN 1104 may be similar to, and substantially interchangeable with, like-named components described elsewhere herein.

The UE 1102 may be communicatively coupled with the AN 1104 via connection 1106. The connection 1106 is illustrated as an air interface to enable communicative coupling, and can be consistent with cellular communications protocols such as an LTE protocol or a 5G NR protocol operating at mmWave or sub-6 GHz frequencies.

The UE 1102 may include a host platform 1108 coupled with a modem platform 1110. The host platform 1108 may include application processing circuitry 1112, which may be coupled with protocol processing circuitry 1114 of the modem platform 1110. The application processing circuitry 1112 may run various applications for the UE 1102 that source/sink application data. The application processing circuitry 1112 may further implement one or more layer operations to transmit/receive application data to/from a data network. These layer operations may include transport (for example UDP) and Internet (for example, IP) operations

The protocol processing circuitry 1114 may implement one or more of layer operations to facilitate transmission or reception of data over the connection 1106. The layer operations implemented by the protocol processing circuitry 1114 may include, for example, MAC, RLC, PDCP, RRC and NAS operations.

The modem platform 1110 may further include digital baseband circuitry 1116 that may implement one or more layer operations that are “below” layer operations performed by the protocol processing circuitry 1114 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1110 may further include transmit circuitry 1118, receive circuitry 1120, RF circuitry 1122, and RF front end (RFFE) 1124, which may include or connect to one or more antenna panels 1126. Briefly, the transmit circuitry 1118 may include a digital-to-analog converter, mixer, intermediate frequency (IF) components, etc.; the receive circuitry 1120 may include an analog-to-digital converter, mixer, IF components, etc.; the RF circuitry 1122 may include a low-noise amplifier, a power amplifier, power tracking components, etc.; RFFE 1124 may include filters (for example, surface/bulk acoustic wave filters), switches, antenna tuners, beamforming components (for example, phase-array antenna components), etc. The selection and arrangement of the components of the transmit circuitry 1118, receive circuitry 1120, RF circuitry 1122, RFFE 1124, and antenna panels 1126 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1114 may include one or more instances of control circuitry (not shown) to provide control functions for the transmit/receive components.

A UE reception may be established by and via the antenna panels 1126, RFFE 1124, RF circuitry 1122, receive circuitry 1120, digital baseband circuitry 1116, and protocol processing circuitry 1114. In some embodiments, the antenna panels 1126 may receive a transmission from the AN 1104 by receive-beamforming signals received by a plurality of antennas/antenna elements of the one or more antenna panels 1126.

A UE transmission may be established by and via the protocol processing circuitry 1114, digital baseband circuitry 1116, transmit circuitry 1118, RF circuitry 1122, RFFE 1124, and antenna panels 1126. In some embodiments, the transmit components of the UE 1104 may apply a spatial filter to the data to be transmitted to form a transmit beam emitted by the antenna elements of the antenna panels 1126.

Similar to the UE 1102, the AN 1104 may include a host platform 1128 coupled with a modem platform 1130. The host platform 1128 may include application processing circuitry 1132 coupled with protocol processing circuitry 1134 of the modem platform 1130. The modem platform may further include digital baseband circuitry 1136, transmit circuitry 1138, receive circuitry 1140, RF circuitry 1142, RFFE circuitry 1144, and antenna panels 1146. The components of the AN 1104 may be similar to and substantially interchangeable with like-named components of the UE 1102. In addition to performing data transmission/reception as described above, the components of the AN 1108 may perform various logical functions that include, for example, RNC functions such as radio bearer management, uplink and downlink dynamic radio resource management, and data packet scheduling.

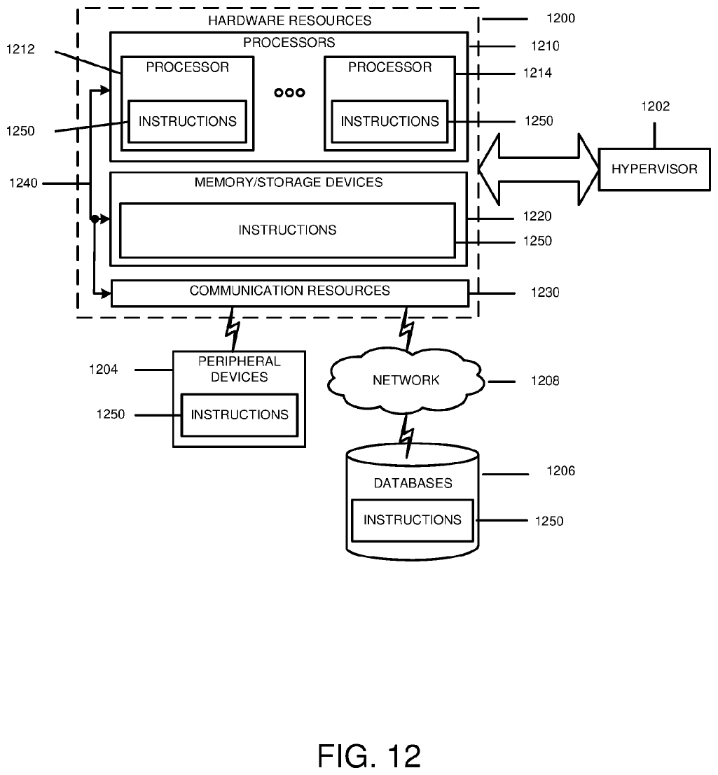

FIG. 12 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240 or other interface circuitry. For embodiments where node virtualization (e.g., NFV) is utilized, a hypervisor 1202 may be executed to provide an execution environment for one or more network slices/sub-slices to utilize the hardware resources 1200.

The processors 1210 may include, for example, a processor 1212 and a processor 1214. The processors 1210 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1220 may include main memory, disk storage, or any suitable combination thereof. The memory/storage devices 620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1230 may include interconnection or network interface controllers, components, or other suitable devices to communicate with one or more peripheral devices 1204 or one or more databases 1206 or other network elements via a network 1208. For example, the communication resources 1230 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

The following examples pertain to further embodiments.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Example 1 may include an apparatus of a user equipment (UE) device for configuring a set of sounding reference signal resources across multiple frequency locations for device positioning, the apparatus comprising processing circuitry coupled to storage for storing information associated with the configuring, the processing circuitry configured to: encode for transmission, by the UE device, a sounding reference signal (SRS) comprising a first set of SRS resources to be used in a first transmission between the user equipment (UE) device and a node B network device at a first time and a second set of SRS resources to be used in a second transmission between the UE device and the node B network device at a second time; decode the first transmission received, in response to the SRS, using the first set of SRS resources and a first bandwidth at the first time; decode the second transmission received, in response to the SRS, using the second set of SRS resources and a second bandwidth at the second time, wherein the first bandwidth partially overlaps the second bandwidth; and combine the first transmission and the second transmission for a device positioning estimation operation based on a combined bandwidth comprising the first bandwidth and the second bandwidth.

Example 2 may include the apparatus of example 1 and/or any other example herein, wherein the first set is the same as the second set.

Example 3 may include the apparatus of example 1 and/or any other example herein, wherein the first set is different than the second set.

Example 4 may include the apparatus of example 1 and/or any other example herein, wherein the first bandwidth is different than the second bandwidth.

Example 5 may include the apparatus of example 1 and/or any other example herein, wherein the first bandwidth is the same as the first bandwidth.

Example 6 may include the apparatus of example 1 and/or any other example herein, wherein the first bandwidth is an active bandwidth part (BWP) at the first time, and wherein the second bandwidth is an inactive bandwidth at the second time.

Example 7 may include the apparatus of example 6 and/or any other example herein, wherein the first transmission and the second transmission are received during a time period designated for SRS resources, and wherein the time period begins prior to at least the second transmission and ends after at least the second transmission is complete.

Example 8 may include the apparatus of example 1 and/or any other example herein, wherein the SRS further comprises a third set of SRS resources to be used in a third transmission by the UE device to the node B network device at a third time, decode the third transmission received, in response to the SRS, using the third set and a third bandwidth at the third time, wherein the combining further comprises combining the third transmission with the first transmission and the second transmission, wherein the combined bandwidth further comprises the third bandwidth, and wherein the third bandwidth partially overlaps the second bandwidth and does not overlap the first bandwidth.

Example 9 may include the apparatus of example 8 and/or any other example herein, wherein the first set, the second set and the third set are defined on a common resource block grid.

Example 10 may include the apparatus of example 1 and/or any other example herein, wherein the first set of SRS resources comprises a first SRS resource associated with the first bandwidth and a second SRS resource associated with the second bandwidth.

Example 11 may include the apparatus of example 1 and/or any other example herein, wherein the processing circuitry is further configured to: encode, for transmission to the UE device, a radio resource control (RRC) message indicative of the first time and the second time.

Example 12 may include the apparatus of example 1 and/or any other example herein, wherein an uplink time window is configured by RRC signaling, with a starting symbol, a starting slot, and a number of symbols and slots.

Example 13 may include the apparatus of example 12 and/or any other example herein, wherein the processing circuitry is further configured to: encode the first set of SRS resources for transmission during the uplink time window; and cancel one or more additional uplink signals or channels during the uplink time window.

Example 14 may include a computer-readable storage medium comprising instructions to cause processing circuitry of a user equipment (UE) device for configuring a set of sounding reference signal resources across multiple frequency locations for device positioning, upon execution of the instructions by the processing circuitry, to: encode for transmission, by the UE device, a sounding reference signal (SRS) comprising a first set of SRS resources to be used in a first transmission between the (UE device and a node B network device at a first time and a second set of SRS resources to be used in a second transmission between the UE device and the node B network device at a second time; decode the first transmission received, in response to the SRS, using the first set and a first bandwidth at the first time; decode the second transmission received, in response to the SRS, device using the second set and a second bandwidth at the second time, wherein the first bandwidth partially overlaps the second bandwidth; and combine the first transmission and the second transmission for a device positioning estimation operation based on a combined bandwidth comprising the first bandwidth and the second bandwidth.

Example 15 may include the computer-readable storage medium of example 14 and/or any other example herein, wherein the first set is the same as the second set.

Example 16 may include the computer-readable storage medium of example 14 and/or any other example herein, wherein the first set is different than the second set.

Example 17 may include a method for configuring a set of sounding reference signal resources across multiple frequency locations for device positioning, the method comprising: encode for transmission, by processing circuitry of a user equipment (UE) device, a sounding reference signal (SRS) comprising a first set of SRS resources to be used in a first transmission between the UE device and a node B network device at a first time and a second set of SRS resources to be used in a second transmission between the UE device and the node B network device at a second time; decoding, by the processing circuitry, the first transmission received, in response to the SRS, using the first set and a first bandwidth at the first time; decoding, by the processing circuitry, the second transmission received, in response to the SRS, using the second set and a second bandwidth at the second time, wherein the first bandwidth partially overlaps the second bandwidth; and combining, by the processing circuitry, the first transmission and the second transmission for a device positioning estimation operation based on a combined bandwidth comprising the first bandwidth and the second bandwidth.

Example 18 may include the method of example 17 and/or any other example herein, wherein the first bandwidth is different than the second bandwidth.

Example 19 may include a computer-readable storage medium comprising instructions to perform the method of any of example 17 or example 18.

Example 20 may include an apparatus comprising means for performing the method of any of example 17 or example 18.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 3) may apply to the examples and embodiments discussed herein.

TABLE 3
Abbreviations

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate Maximum Bit |
| | Rate |
| AMF | Access and Mobility |
| | Management Function |
| AN | Access Network |
| ANR | Automatic Neighbour |
| | Relation |
| AP | Application Protocol, |
| | Antenna Port, Access |
| | Point |
| API | Application Programming |
| | Interface |
| APN | Access Point Name |
| ARP | Allocation and Retention |
| | Priority |
| ARQ | Automatic Repeat |
| | Request |
| AS | Access Stratum |
| ASP | Application Service |
| | Provider |
| ASN.1 | Abstract Syntax Notation |
| | One |
| AUSF | Authentication Server |
| | Function |
| AWGN | Additive White Gaussian |
| | Noise |
| BAP | Backhaul Adaptation |
| | Protocol |
| BCH | Broadcast Channel |
| BER | Bit Error Ratio |
| BFD | Beam Failure Detection |
| BLER | Block Error Rate |
| BPSK | Binary Phase Shift |
| | Keying |
| BRAS | Broadband Remote |
| | Access Server |
| BSS | Business Support |
| | System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based |
| | Random Access |
| CC | Component Carrier, |
| | Country Code, |
| | Cryptographic Checksum |
| CCA | Clear Channel |
| | Assessment |
| CCE | Control Channel Element |
| CCCH | Common Control |
| | Channel |
| CE | Coverage Enhancement |
| CDM | Content Delivery |
| | Network |
| CDMA | Code-Division Multiple |
| | Access |
| CFRA | Contention Free Random |
| | Access |
| CG | Cell Group |
| CGF | Charging Gateway |
| | Function |
| CHF | Charging Function |
| CI | Cell Identity |
| CID | Cell-ID (e.g., positioning |
| | method) |
| CIM | Common Information |
| | Model |
| CIR | Carrier to Interference |
| | Ratio |
| CK | Cipher Key |
| CM | Connection |
| | Management, |
| | Conditional Mandatory |
| CMAS | Commercial Mobile Alert |
| | Service |
| CMD | Command |
| CMS | Cloud Management |
| | System |
| CO | Conditional Optional |
| CoMP | Coordinated Multi-Point |
| CORESET | Control Resource Set |
| COTS | Commercial Off-The- |
| | Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot Channel |
| CQI | Channel Quality |
| | Indicator |
| CPU | CSI processing unit, |
| | Central Processing Unit |
| C/R | Command/Response |
| | field bit |
| CRAN | Cloud Radio Access |
| | Network, Cloud RAN |
| CRB | Common Resource Block |
| CRC | Cyclic Redundancy |
| | Check |
| CRI | Channel-State |
| | Information Resource |
| | Indicator, CSI-RS |
| | Resource Indicator |
| C-RNTI | Cell RNTI |
| CS | Circuit Switched |
| CSAR | Cloud Service Archive |
| CSI | Channel-State |
| | Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise |
| | and interference ratio |
| CSMA | Carrier Sense Multiple |
| | Access |
| CSMA/CA | CSMA with collision |
| | avoidance |
| CSS | Common Search Space, |
| | Cell-specific Search |
| | Space |
| CTF | Charging Trigger |
| | Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, DMRS | Demodulation |
| | Reference Signal |
| DN | Data network |
| DNN | Data Network Name |
| DNAI | Data Network Access |
| | Identifier |
| DRB | Data Radio Bearer |
| DRS | Discovery Reference |
| | Signal |
| DRX | Discontinuous Reception |
| DSL | Domain Specific |
| | Language. Digital |
| | Subscriber Line |
| DSLAM | DSL Access Multiplexer |
| DwPTS | Downlink Pilot Time Slot |
| E-LAN | Ethernet Local Area |
| | Network |
| E2E | End-to-End |
| ECCA | extended clear channel |
| | assessment, extended |
| | CCA |
| ECCE | Enhanced Control |
| | Channel Element, |
| | Enhanced CCE |
| ED | Energy Detection |
| EDGE | Enhanced Datarates for |
| | GSM Evolution (GSM |
| | Evolution) |
| EAS | Edge Application Server |
| EASID | Edge Application Server |
| | Identification |
| ECS | Edge Configuration |
| | Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting |
| | Environment |
| EGMF | Exposure Governance |
| | tableManagement |
| | Function |
| EGPRS | Enhanced GPRS |
| EIR | Equipment Identity |
| | Register |
| eLAA | enhanced Licensed |
| | Assisted Access, |
| | enhanced LAA |
| EM | Element Manager |
| eMBB | Enhanced Mobile |
| | Broadband |
| EMS | Element Management |
| | System |
| eNB | evolved NodeB, E- |
| | UTRAN Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, |
| | enhanced resource |
| | element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane |
| | interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division |
| | Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier |
| | Transformation |
| feLAA | further enhanced |
| | Licensed Assisted |
| | Access, further |
| | enhanced LAA |
| FN | Frame Number |
| FPGA | Field-Programmable |
| | Gate Array |
| FR | Frequency Range |
| FQDN | Fully Qualified Domain |
| | Name |
| G-RNTI | GERAN Radio Network |
| | Temporary Identity |
| GERAN | GSM EDGE RAN, GSM |
| | EDGE Radio Access |
| | Network |
| GGSN | Gateway GPRS Support |
| | Node |
| GLONASS | GLObal'naya |
| | NAvigatsionnaya |
| | Sputnikovaya Sistema |
| | (Engl.: Global Navigation |
| | Satellite System) |
| gNB | Next Generation NodeB |
| gNB-CUg | NB-centralized unit, |
| | Next Generation NodeB |
| | centralized unit |
| gNB-DUg | NB-distributed unit, |
| | Next Generation NodeB |
| | distributed unit |
| GNSS | Global Navigation |
| | Satellite System |
| GPRS | General Packet Radio |
| | Service |
| GPSI | Generic Public |
| | Subscription Identifier |
| GSM | Global System for Mobile |
| | Communications, |
| | Groupe Spécial Mobile |
| GTP | GPRS Tunneling Protocol |
| GTP-U | GPRS Tunnelling |
| | Protocol for User Plane |
| GTS | Go To Sleep Signal |
| | (related to WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat |
| | Request |
| HANDO | Handover |
| HFN | HyperFrame Number |
| HHO | Hard Handover |
| HLR | Home Location Register |
| HN | Home Network |
| HO | Handover |
| HPLMN | Home Public Land |
| | Mobile Network |
| HSDPA | High Speed Downlink |
| | Packet Access |
| HSN | Hopping Sequence |
| | Number |
| HSPA | High Speed Packet |
| | Access |
| HSS | Home Subscriber Server |
| HSUPA | High Speed Uplink |
| | Packet Access |
| HTTP | Hyper Text Transfer |
| | Protocol |
| HTTPS | Hyper Text Transfer |
| | Protocol Secure (https is |
| | http/1.1 over SSL, i.e. |
| | port 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of |
| | Electrical and |
| | Electronics |
| | Engineers |
| IEI | Information |
| | Element Identifier |
| IEIDL | Information |
| | Element Identifier |
| | Data Length |
| IETF | Internet |
| | Engineering Task |
| | Force |
| IF | Infrastructure |
| IM | Interference |
| | Measurement, |
| | Intermodulation, IP |
| | Multimedia |
| IMC | IMS Credentials |
| IMEI | International |
| | Mobile Equipment |
| | Identity |
| IMGI | International |
| | mobile group |
| | identity |
| IMPI | IP Multimedia |
| | Private Identity |
| IMPU | IP Multimedia |
| | PUblic identity |
| IMS | IP Multimedia |
| | Subsystem |
| IMSI | International |
| | Mobile Subscriber |
| | Identity |
| IoT | Internet of Things |
| IP | Internet Protocol |
| Ipsec | IP Security, |
| | Internet Protocol |
| | Security |
| IP-CAN | IP-Connectivity |
| | Access Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration |
| | Reference Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking- |
| | Function |
| I-WLAN | Interworking WLAN |
| | Constraint length of |
| | the convolutional code, |
| | USIM Individual key |
| kB | Kilobyte (1000 |
| | bytes) |
| kbps | kilo-bits per second |
| Kc | Ciphering key |
| Ki | Individual |
| | subscriber |
| | authentication key |
| KPI | Key Performance |
| | Indicator |
| KQI | Key Quality |
| | Indicator |
| KSI | Key Set Identifier |
| ksps | kilo-symbols per |
| | second |
| KVM | Kernel Virtual |
| | Machine |
| L1 | Layer 1 (physical |
| | layer) |
| L1-RSRP | Layer 1 |
| | reference signal |
| | received power |
| L2 | Layer 2 (data link |
| | layer) |
| L3 | Layer 3 (network |
| | layer) |
| LAA | Licensed Assisted |
| | Access |
| LAN | Local Area Network |
| LADN | Local Area Data |
| | Network |
| LBT | Listen Before Talk |
| LCM | LifeCycle |
| | Management |
| LCR | Low Chip Rate |
| LCS | Location Services |
| LCID | Logical Channel ID |
| LI | Layer Indicator |
| LLC | Logical Link |
| | Control, Low Layer |
| | Compatibility |
| LPLMN | Local PLMN |
| LPP | LTE Positioning |
| | Protocol |
| LSB | Least Significant Bit |
| LTE | Long Term |
| | Evolution |
| LWA | LTE-WLAN |
| | aggregation |
| LWIP | LTE/WLAN Radio |
| | Level Integration |
| | with IPsec Tunnel |
| LTE | Long Term |
| | Evolution |
| M2M | Machine-to- |
| | Machine |
| MAC | Medium Access |
| | Control (protocol |
| | layering context) |
| MAC | Message |
| | authentication code |
| | (security/encryption |
| | context) |
| MAC-A | MAC used for |
| | authentication and |
| | key agreement |
| | (TSG T WG3 |
| | context) |
| MAC-I | MAC used for data |
| | integrity of |
| | signalling messages |
| | (TSG T WG3 |
| | context) |
| MANO | Management and |
| | Orchestration |
| MBMS | Multimedia |
| | Broadcast and |
| | Multicast Service |
| MBSFN | Multimedia |
| | Broadcast multicast |
| | service Single |
| | Frequency Network |
| MCC | Mobile Country |
| | Code |
| MCG | Master Cell Group |
| MCOT | Maximum Channel |
| | Occupancy Time |
| MCS | Modulation and |
| | coding scheme |
| MDAF | Management Data |
| | Analytics Function |
| MDAS | Management Data |
| | Analytics Service |
| MDT | Minimization of |
| | Drive Tests |
| ME | Mobile Equipment |
| MeNB | master eNB |
| MER | Message Error |
| | Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location |
| | Centre |
| MM | Mobility |
| | Management |
| MME | Mobility |
| | Management Entity |
| MN | Master Node |
| MNO | Mobile Network |
| | Operator |
| MO | Measurement |
| | Object, Mobile |
| | Originated |
| MPBCH | MTC Physical |
| | Broadcast CHannel |
| MPDCCH | MTC Physical |
| | Downlink Control |
| | CHannel |
| MPDSCH | MTC Physical |
| | Downlink Shared |
| | CHannel |
| MPRACH | MTC Physical |
| | Random Access |
| | CHannel |
| MPUSCH | MTC Physical |
| | Uplink Shared |
| | Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling |
| | Information |
| MSID | Mobile Station |
| | Identifier |
| MSIN | Mobile Station |
| | Identification |
| | Number |
| MSISDN | Mobile |
| | Subscriber ISDN |
| | Number |
| MT | Mobile Terminated, |
| | Mobile Termination |
| MTC | Machine-Type |
| | Communications |
| mMTC | massive MTC, |
| | massive Machine- |
| | Type |
| | Communications |
| MU-MIMO | Multi User MIMO |
| MWUS | MTC wake-up |
| | signal, MTC WUS |
| NACK | Negative |
| | Acknowledgement |
| NAI | Network Access |
| | Identifier |
| NAS | Non-Access |
| | Stratum, Non- |
| | Access Stratum |
| | layer |
| NCT | Network |
| | Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network |
| | Forwarding Path |
| NFPD | Network |
| | Forwarding Path |
| | Descriptor |
| NFV | Network Functions |
| | Virtualization |
| NFVI | NFV Infrastructure |
| NFVO | NFV Orchestrator |
| NG | Next Generation, |
| | Next Gen |
| NGEN-DC | NG-RAN E-UTRA- |
| | NR Dual |
| | Connectivity |
| NM | Network Manager |
| NMS | Network |
| | Management |
| | System |
| N-PoP | Network Point of |
| | Presence |
| NMIB, N-MIB | Narrowband |
| | MIB |
| NPBCH | Narrowband |
| | Physical Broadcast |
| | CHannel |
| NPDCCH | Narrowband |
| | Physical Downlink |
| | Control CHannel |
| NPDSCH | Narrowband |
| | Physical Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband |
| | Primary |
| | Synchronization |
| | Signal |
| NSSS | Narrowband |
| | Secondary |
| | Synchronization |
| | Signal |
| NR | New Radio, |
| | Neighbour Relation |
| NRF | NF Repository |
| | Function |
| NRS | Narrowband |
| | Reference Signal |
| NS | Network Service |
| NSA | Non-Standalone operation mode |
| NSD | Network Service |
| | Descriptor |
| NSR | Network Service |
| | Record |
| NSSAI | Network Slice |
| | Selection |
| | Assistance |
| | Information |
| S-NNSAI | Single-NSSAI |
| NSSF | Network Slice |
| | Selection Function |
| NW | Network |
| NWUS | Narrowband wake- |
| | up signal, |
| | Narrowband WUS |
| NZP | Non-Zero Power |
| O&M | Operation and |
| | Maintenance |
| ODU2 | Optical channel |
| | Data Unit - type 2 |
| OFDM | Orthogonal |
| | Frequency Division |
| | Multiplexing |
| OFDMA | Orthogonal |
| | Frequency Division |
| | Multiple Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average |
| | Power Ratio |
| PAR | Peak to Average |
| | Ratio |
| PBCH | Physical Broadcast |
| | Channel |
| PC | Power Control, |
| | Personal Computer |
| PCC | Primary Component |
| | Carrier, Primary CC |
| PCell | Primary Cell |
| PCI | Physical Cell ID, |
| | Physical Cell |
| | Identity |
| PCEF | Policy and Charging |
| | Enforcement |
| | Function |
| PCF | Policy Control |
| | Function |
| PCRFPolicy | Control and |
| | Charging Rules |
| | Function |
| PDCP | Packet Data |
| | Convergence |
| | Protocol, Packet |
| | Data Convergence |
| | Protocol layer |
| PDCCH | Physical Downlink |
| | Control Channel |
| PDCP | Packet Data |
| | Convergence |
| | Protocol |
| PDN | Packet Data |
| | Network, Public |
| | Data Network |
| PDSCH | Physical Downlink |
| | Shared Channel |
| PDU | Protocol Data Unit |
| PEI | Permanent |
| | Equipment |
| | Identifiers |
| PFD | Packet Flow |
| | Description |
| P-GW | PDN Gateway |
| PHICH | Physical hybrid- |
| | ARQ indicator |
| | channel |
| PHY | Physical layer |
| PLMN | Public Land Mobile |
| | Network |
| PIN | Personal |
| | Identification |
| | Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point |
| | Protocol |
| PRACH | Physical RACH |
| PRB | Physical resource |
| | block |
| PRG | Physical resource |
| | block group |
| ProSe | Proximity Services, |
| | Proximity-Based |
| | Service |
| PRS | Positioning |
| | Reference Signal |
| PRR | Packet Reception |
| | Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization |
| | Signal |
| PSTN | Public Switched |
| | Telephone Network |
| PT-RS | Phase-tracking |
| | reference signal |
| PTT | Push-to-Talk |
| PUCCH | Physical Uplink |
| | Control Channel |
| PUSCH | Physical Uplink |
| | Shared Channel |
| QAM | Quadrature |
| | Amplitude Modulation |
| QCI | QoS class of identifier |
| QCL | Quasi co-location |
| QFI | QoS Flow ID, QoS |
| | Flow Identifier |
| QoS | Quality of Service |
| QPSK | Quadrature |
| | (Quaternary) Phase |
| | Shift Keying |
| QZSS | Quasi-Zenith Satellite |
| | System |
| RA-RNTI | Random Access |
| | RNTI |
| RAB | Radio Access Bearer, |
| | Random Access Burst |
| RACH | Random Access |
| | Channel |
| RADIUS | Remote |
| | Authentication Dial In |
| | User Service |
| RAN | Radio Access |
| | Network |
| RAND | RANDom number |
| | (used for |
| | authentication) |
| RAR | Random Access |
| | Response |
| RAT | Radio Access |
| | Technology |
| RAU | Routing Area Update |
| RB | Resource block, |
| | Radio Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator |
| | value |
| RL | Radio Link |
| RLC | Radio Link Control, |
| | Radio Link Control |
| | layer |
| RLC AM | RLC Acknowledged |
| | Mode |
| RLC UM | RLC |
| | Unacknowledged |
| | Mode |
| RLF | Radio Link Failure |
| RLM | Radio Link Monitoring |
| RLM-RS | Reference |
| | Signal for RLM |
| RM | Registration |
| | Management |
| RMC | Reference |
| | Measurement |
| | Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource |
| | Control, Radio |
| | Resource Control |
| | layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal |
| | Time difference |
| RTP | Real Time Protocol |
| RTS | Ready-To-Send |
| RTT | Round Trip Time |
| Rx | Reception, Receiving, |
| | Receiver |
| S1AP | S1 Application |
| | Protocol |
| S1-MME | S1 for the control |
| | plane |
| S1-U | S1 for the user plane |
| S-GW | Serving Gateway |
| S-RNTI | SRNC Radio Network |
| | Temporary Identity |
| S-TMSI | SAE Temporary |
| | Mobile Station |
| | Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary |
| | Component Carrier, |
| | Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data |
| | Adaptation Protocol, |
| | Service Data |
| | Adaptation Protocol |
| | layer |
| SDL | Supplementary |
| | Downlink |
| SDNF | Structured Data |
| | Storage Network |
| | Function |
| SDP | Session Description |
| | Protocol |
| SDSF | Structured Data |
| | Storage Function |
| SDU | Service Data Unit |
| SEAF | Security Anchor |
| | Function |
| SeNB | secondary eNB |
| SEPP | Security Edge |
| | Protection Proxy |
| SFI | Slot format indication |
| SFTD | Space-Frequency |
| | Time Diversity, SFN |
| | and frame timing |
| | difference |
| SFN | System Frame |
| | Number |
| SgNB | Secondary gNB |
| SGSN | Serving GPRS |
| | Support Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message |
| | Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent |
| | CSI RNTI |
| SPS | Semi-Persistent |
| | Scheduling |
| SQN | Sequence number |
| SR | Scheduling Request |
| SRB | Signalling Radio |
| | Bearer |
| SRS | Sounding Reference |
| | Signal |
| SS | Synchronization |
| | Signal |
| SSB | Synchronization |
| | Signal Block |
| SSID | Service Set Identifier |
| SS/PBCH | Block |
| SSBRI | SS/PBCH Block |
| | Resource Indicator, |
| | Synchronization |
| | Signal Block Resource |
| | Indicator |
| SSC | Session and Service |
| | Continuity |
| SS-RSRP | Synchronization |
| | Signal based |
| | Reference Signal |
| | Received Power |
| SS-RSRQ | Synchronization |
| | Signal based |
| | Reference Signal |
| | Received Quality |
| SS-SINR | Synchronization |
| | Signal based Signal |
| | to Noise and |
| | Interference Ratio |
| SSS | Secondary |
| | Synchronization |
| | Signal |
| SSSG | Search Space Set |
| | Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance |
| | Group |
| TAI | Tracking Area |
| | Identity |
| TAU | Tracking Area Update |
| TB | Transport Block |
| TBS | Transport Block Size |
| TBD | To Be Defined |
| TCI | Transmission |
| | Configuration |
| | Indicator |
| TCP | Transmission |
| | Communication |
| | Protocol |
| TDD | Time Division Duplex |
| TDM | Time Division |
| | Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power |
| | Control |
| TPMI | Transmitted |
| | Precoding Matrix |
| | Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN Radio |
| | Network Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured Data |
| | Storage Network |
| | Function |
| UICC | Universal Integrated |
| | Circuit Card |
| UL | Uplink |
| UM | Unacknowledged |
| | Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and |
| | Low Latency |
| USB | Universal Serial Bus |
| USIM | Universal Subscriber |
| | Identity Module |
| USS | UE-specific search |
| | space |
| UTRA | UMTS Terrestrial |
| | Radio Access |
| UTRAN | Universal Terrestrial |
| | Radio Access |
| | Network |
| UwPTS | Uplink Pilot Time Slot |
| V2I | Vehicle-to- |
| | Infrastruction |
| V2P | Vehicle-to-Pedestrian |
| V2V | Vehicle-to-Vehicle |
| V2X | Vehicle-to-everything |
| VIM | Virtualized |
| | Infrastructure |
| | Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding |
| | Graph |
| VNFFGD | VNF Forwarding |
| | Graph Descriptor |
| VNFM | VNF Manager |
| VoIP | Voice-over-IP, Voice- |
| | over-Internet |
| | Protocol |
| VPLMN | Visited Public Land |
| | Mobile Network |
| VPN | Virtual Private |
| | Network |
| VRB | Virtual Resource |
| | Block |
| WiMAX | Worldwide |
| | Interoperability for |
| | Microwave Access |
| WLAN | Wireless Local Area |
| | Network |
| WMAN | Wireless Metropolitan |
| | Area Network |
| WPAN | Wireless Personal |
| | Area Network |
| X2-C | X2-Control plane |
| X2-U | X2-User plane |
| XML | eXtensible Markup |
| | Language |
| XRES | EXpected user |
| | RESponse |
| XOR | eXclusive OR |
| ZC | Zadoff-Chu |
| ZP | Zero Po |

What is claimed is:

1. An apparatus of a user equipment (UE) device for configuring a set of sounding reference signal resources across multiple frequency locations for device positioning, the apparatus comprising processing circuitry coupled to storage for storing information associated with the configuring, the processing circuitry configured to:
encode for transmission, by the UE device, a sounding reference signal (SRS) comprising a first set of SRS resources to be used in a first transmission between the user equipment (UE) device and a node B network device at a first time and a second set of SRS resources to be used in a second transmission between the UE device and the node B network device at a second time;
decode the first transmission received, in response to the SRS, using the first set of SRS resources and a first bandwidth at the first time;
decode the second transmission received, in response to the SRS, using the second set of SRS resources and a second bandwidth at the second time, wherein the first bandwidth partially overlaps the second bandwidth; and
combine the first transmission and the second transmission for a device positioning estimation operation based on a combined bandwidth comprising the first bandwidth and the second bandwidth.

2. The apparatus of claim 1, wherein the first set is the same as the second set.

3. The apparatus of claim 1, wherein the first set is different than the second set.

4. The apparatus of claim 1, wherein the first bandwidth is different than the second bandwidth.

5. The apparatus of claim 1, wherein the first bandwidth is the same as the first bandwidth.

6. The apparatus of claim 1, wherein the first bandwidth is an active bandwidth part (BWP) at the first time, and wherein the second bandwidth is an inactive bandwidth at the second time.

7. The apparatus of claim 6, wherein the first transmission and the second transmission are received during a time period designated for SRS resources, and wherein the time period begins prior to at least the second transmission and ends after at least the second transmission is complete.

8. The apparatus of claim 1, wherein the SRS further comprises a third set of SRS resources to be used in a third transmission by the UE device to the node B network device at a third time,
decode the third transmission received, in response to the SRS, using the third set and a third bandwidth at the third time,
wherein the combining further comprises combining the third transmission with the first transmission and the second transmission, wherein the combined bandwidth further comprises the third bandwidth, and
wherein the third bandwidth partially overlaps the second bandwidth and does not overlap the first bandwidth.

9. The apparatus of claim 8, wherein the first set, the second set and the third set are defined on a common resource block grid.

10. The apparatus of claim 1, wherein the first set of SRS resources comprises a first SRS resource associated with the first bandwidth and a second SRS resource associated with the second bandwidth.

11. The apparatus of claim 1, wherein the processing circuitry is further configured to:
encode, for transmission to the UE device, a radio resource control (RRC) message indicative of the first time and the second time.

12. The apparatus of claim 1, wherein an uplink time window is configured by RRC signaling, with a starting symbol, a starting slot, and a number of symbols and slots.

13. The apparatus of claim 12, wherein the processing circuitry is further configured to:
encode the first set of SRS resources for transmission during the uplink time window; and
cancel one or more additional uplink signals or channels during the uplink time window.

14. A non-transitory computer-readable storage medium comprising instructions to cause processing circuitry of a user equipment (UE) device for configuring a set of sounding reference signal resources across multiple frequency locations for device positioning, upon execution of the instructions by the processing circuitry, to:
encode for transmission, by the UE device, a sounding reference signal (SRS) comprising a first set of SRS resources to be used in a first transmission between the (UE device and a node B network device at a first time and a second set of SRS resources to be used in a second transmission between the UE device and the node B network device at a second time;
decode the first transmission received, in response to the SRS, using the first set and a first bandwidth at the first time;
decode the second transmission received, in response to the SRS, device using the second set and a second bandwidth at the second time, wherein the first bandwidth partially overlaps the second bandwidth; and
combine the first transmission and the second transmission for a device positioning estimation operation based on a combined bandwidth comprising the first bandwidth and the second bandwidth.

15. The non-transitory computer-readable storage medium of claim 14, wherein the first set is the same as the second set.

16. The non-transitory computer-readable storage medium of claim 14, wherein the first set is different than the second set.

17. A method for configuring a set of sounding reference signal resources across multiple frequency locations for device positioning, the method comprising:
encode for transmission, by processing circuitry of a user equipment (UE) device, a sounding reference signal (SRS) comprising a first set of SRS resources to be used in a first transmission between the UE device and a node B network device at a first time and a second set of SRS resources to be used in a second transmission between the UE device and the node B network device at a second time;
decoding, by the processing circuitry, the first transmission received, in response to the SRS, using the first set and a first bandwidth at the first time;
decoding, by the processing circuitry, the second transmission received, in response to the SRS, using the second set and a second bandwidth at the second time, wherein the first bandwidth partially overlaps the second bandwidth; and
combining, by the processing circuitry, the first transmission and the second transmission for a device positioning estimation operation based on a combined bandwidth comprising the first bandwidth and the second bandwidth.

18. The method of claim 17, wherein the first bandwidth is different than the second bandwidth.

19. A non-transitory computer-readable storage medium comprising instructions to perform the method of claim 17.

20. An apparatus comprising means for performing the method of claim 17.
